(19) United States
(12) Patent Application Publication
(10) Pub. No.: US 2021/0073953 A1
(43) Pub. Date: Mar. 11, 2021

(54) METHOD FOR APPLYING BOKEH EFFECT TO IMAGE AND RECORDING MEDIUM

(71) Applicant: NALBI INC., Seoul (KR)

(72) Inventor: Young Su LEE, Seoul (KR)

(73) Assignee: NALBI INC., Seoul (KR)

(21) Appl. No.: 17/101,320

(22) Filed: Nov. 23, 2020

Related U.S. Application Data
(63) Continuation of application No. PCT/KR2019/010449, filed on Aug. 16, 2019.

(30) Foreign Application Priority Data
Aug. 16, 2018 (KR) 10-2018-0095255
Oct. 12, 2018 (KR) 10-2018-0121628
Oct. 12, 2018 (KR) 10-2018-0122100
Nov. 2, 2018 (KR) 10-2018-0133885
Aug. 16, 2019 (KR) 10-2019-0100550

(51) Int. Cl. G06T 5/00; G06T 7/571; G06N 3/04; G06N 3/08

(52) U.S. Cl. CPC G06T 5/002; G06T 7/571; G06N 3/0454; G06T 2207/20081; G06T 2207/20224; G06T 2207/20084; G06N 3/084

(57) ABSTRACT

A method for applying a bokeh effect on an image at a user terminal is provided. The method for applying a bokeh effect may include: receiving an image and inputting the received image to an input layer of a first artificial neural network model to generate a depth map indicating depth information of pixels in the image; and applying the bokeh effect on the pixels in the image based on the depth map indicating the depth information of the pixels in the image. The first artificial neural network model may be generated by receiving a plurality of reference images to the input layer and performing machine learning to infer the depth information included in the plurality of reference image.

### CROSS REFERENCE TO RELATED APPLICATIONS

This application is a continuation of International Application No. PCT/KR2019/010449 filed on Aug. 16, 2019 which claims priority to Korean Patent Application No. 10-2018-0095255 filed on Aug. 16, 2018, Korean Patent Application No. 10-2018-0121628 filed on Oct. 12, 2018, Korean Patent Application No. 10-2018-0122100 filed on Oct. 12, 2018, Korean Patent Application No. 10-2018-0133885 filed on Nov. 2, 2018, and Korean Patent Application No. 10-2019-0100550 filed on Aug. 16, 2019, the entire contents of which are herein incorporated by reference.

### TECHNICAL FIELD

The disclosure relates to a method for providing a bokeh effect to an image using computer vision technology and a recording medium.

### BACKGROUND ART

Recently, the fast advancement and distribution of the portable terminals have led into widespread use of image photography with camera devices or the like provided in the portable terminal devices. It replaced the traditional ways that required the presence of separate camera devices in order to photograph an image. Furthermore, in recent years, beyond simply photographing and acquiring images from smartphones, users had increasing interests in acquiring high-quality images as provided by the advanced camera equipment, or those images or photos on which advanced image processing techniques are applied.

The bokeh effect is one of the image photography techniques. The bokeh effect refers to the aesthetic quality of blur of the out-of-focus parts of a photographed image. It is the effect that blurs the front or back of the focal plane while the focal plane remains clear, to emphasize the focal plane. In a broad sense, the bokeh effect refers to not only applying the out-of-focus effect (processing with blur or hazy backdrops) to the unfocused region, but also to focusing or highlighting the in-focus region.

Equipment with a large lens, for example, a DSLR can achieve a dramatic bokeh effect by using a shallow depth. However, a portable terminal has a difficulty in implementing the bokeh effect comparable to the DSLR due to structural issues. In particular, the bokeh effect provided by the DSLR camera can be basically generated with a specific shape of the aperture mounted on the camera lens (e.g., the shape of one or more aperture blades), but, unlike the DSLR camera, the camera of the portable terminal uses a lens without an aperture blade due to manufacturing cost and/or size of the portable terminal, which makes it difficult to implement the bokeh effect.

Due to such circumstances, in order to implement such a bokeh effect, the related portable terminal cameras use a method such as configuring two or more RGB cameras, measuring a distance with an infrared distance sensor at the time of photographing image, or the like.

### SUMMARY

### Technical Problem

An object of the present disclosure is to disclose a device and method for implementing an out-of-focus and/or in-focus effect, that is, a bokeh effect that can be implemented with a high-quality camera, on an image photographed from a smartphone camera or the like, through computer vision technology.

### Technical Solution

A method for applying a bokeh effect to an image at a user terminal according to an embodiment may include receiving an image and inputting the received image to an input layer of a first artificial neural network model to generate a depth map indicating depth information of pixels in the image; and applying the bokeh effect to the pixels in the image based on the depth map indicating the depth information of the pixels in the image, and the first artificial neural network model may be generated by receiving a plurality of reference images to the input layer and performing machine learning to infer the depth information included in the plurality of reference images.

According to an embodiment, the method may further include generating a segmentation mask for an object included in the received image, in which the generating the depth map may include correcting the depth map using the generated segmentation mask.

According to an embodiment, the applying of the bokeh effect may include: determining a reference depth corresponding to the segmentation mask, calculating a difference between the reference depth and a depth of other pixels in a region other than the segmentation mask in the image, and applying the bokeh effect to the image based on the calculated differences.

According to an embodiment, in the method for applying a bokeh effect, a second artificial neural network model may be generated through machine learning, in which the second artificial neural network model may be configured to receive the plurality of reference images to an input layer and infer the segmentation mask in the plurality of reference images, and the generating the segmentation mask may include inputting the received image to the input layer of the second artificial neural network model to generate a segmentation mask for the object included in the received image.

According to an embodiment, the method for applying the bokeh effect may further include generating a detection region that detects the object included in the received image, in which the generating the segmentation mask may include generating the segmentation mask for the object in the generated detection region.

According to an embodiment, the method for applying the bokeh effect may further include receiving setting information on the bokeh effect to be applied, in which the received image may include a plurality of objects, the generating of the detection region may include generating a plurality of detection regions that detect each of the plurality of objects included in the received image, the generating the segmentation mask may include generating a plurality of segmentation masks for each of the plurality of objects in each of the plurality of detection regions, and the applying the bokeh effect may include, when the setting information indicates a selection for at least one segmentation mask among the plurality of segmentation masks, applying out-of-focus to a region other than a region corresponding to the at least one selected segmentation mask of the region in the image.

According to an embodiment, in the method for applying a bokeh effect, a third artificial neural network model may be generated through machine learning, in which the third artificial neural network model may be configured to receive a plurality of reference segmentation masks to an input layer and infer depth information of the plurality of reference segmentation masks, the generating the depth map may include inputting the segmentation mask to the input layer of the third artificial neural network model and determining depth information corresponding to the segmentation mask, and the applying the bokeh effect may include applying the bokeh effect to the segmentation mask based on the depth information of the segmentation mask.

According to an embodiment, the generating the depth map may include performing pre-processing of the image to generate data required for the input layer of the first artificial neural network model.

According to an embodiment, the generating the depth map may include determining at least one object in the image through the first artificial neural network model, and the applying the bokeh effect may include: determining a reference depth corresponding to the at least one determined object, calculating a difference between the reference depth and a depth of each of the other pixels in the image, and applying the bokeh effect to the image based on the calculated difference.

According to an embodiment, a computer-readable recording medium storing a computer program for executing, on a computer, the method of applying a bokeh effect to an image at a user terminal described above, is provided.

### Advantageous Effects

According to some embodiments, since the bokeh effect is applied based on depth information of the depth map generated using the trained artificial neural network model, a dramatic bokeh effect can be applied on an image photographed from entry-level equipment, such as a smartphone camera, for example, without the need for the depth image or infrared sensor that requires expensive equipment. In addition, the bokeh effect may not be applied at the time of photographing, but can be applied afterwards on a stored image file, for example, on a single image file in RGB or YUV format.

According to some embodiments, since the depth map is corrected using the segmentation mask for the object in the image, an error in the generated depth map can be compensated to more clearly distinguish between a subject and a background, so that the desired bokeh effect can be obtained. In addition, a further improved bokeh effect can be applied, since the problem that a certain area is blurred due to a difference in depth even inside the subject which is a single object.

In addition, according to some embodiments, a bokeh effect specialized for a specific object can be applied by using a separate trained artificial neural network model for the specific object. For example, by using the artificial neural network model that is separately trained for a person, a more detailed depth map can be obtained for the person region, and a more dramatic bokeh effect can be applied.

According to some embodiments, a user experience (UX) that can allow the user to easily and effectively apply the bokeh effect is provided on a terminal including an input device such as a touch screen.

### BRIEF DESCRIPTION OF THE DRAWINGS

FIG. 1 is an exemplary diagram showing a process of a bokeh effect applying device of generating a depth map from an image and applying a bokeh effect based on the same according to an embodiment.

FIG. 2 is a block diagram showing a configuration of a bokeh effect applying device according to an embodiment.

FIG. 3 is a schematic diagram showing a method for training an artificial neural network model according to an embodiment.

FIG. 4 is a flowchart showing a method of a bokeh effect applying device for correcting a depth map based on a segmentation mask generated from an image and applying a bokeh effect using the corrected depth map according to an embodiment.

FIG. 5 is a schematic diagram showing a process of a bokeh effect applying device of generating a segmentation mask for a person included in an image and applying a bokeh effect to the image based on a corrected depth map according to an embodiment.

FIG. 6 is a comparison diagram shown by a device according to an embodiment, showing a comparison between a depth map generated from an image and a depth map corrected based on a segmentation mask corresponding to the image.

FIG. 7 is an exemplary diagram obtained as a result of, at a bokeh effect applying device, determining a reference depth corresponding to a selected object in an image, calculating a difference between the reference depth and a depth of the other pixels, and applying a bokeh effect to an image based on the same according to an embodiment.

FIG. 8 is a schematic diagram showing a process of a bokeh effect applying device of generating a depth map from an image, determining the object in the image using a trained artificial neural network model, and applying a bokeh effect based on the same according to an embodiment.

FIG. 9 is a flowchart showing a process of a bokeh effect applying device of generating a segmentation mask for an object included in an image, inputting the mask into an input layer of a separately trained artificial neural network model in the process of applying a bokeh effect, acquiring depth information of the mask, and applying the bokeh effect to the mask based on the same according to an embodiment.

FIG. 10 is an exemplary diagram showing a process of a bokeh effect applying device of generating a segmentation mask for a plurality of objects included in an image, and applying a bokeh effect based on the segmentation mask selected from the same according to an embodiment.

FIG. 11 is an exemplary diagram showing a process of changing a bokeh effect according to setting information on bokeh effect application received at the bokeh effect applying device according to an embodiment.

FIG. 12 is an exemplary diagram showing a process of a bokeh effect applying device of extracting a narrower region from a background in an image and implementing an effect of zooming a telephoto lens as the bokeh blur intensity increases, according to an embodiment.

FIG. 13 is a flowchart showing a method of a user terminal according to an embodiment of applying a bokeh effect to an image.

FIG. 14 is a block diagram of a bokeh effect application system according to an embodiment.

### DETAILED DESCRIPTION OF THE INVENTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding components are given the same reference numerals. In addition, in the following description of the embodiments, duplicate descriptions of the same or corresponding components may be omitted. However, even if descriptions of components are omitted, it is not intended that such components are not included in any embodiment.

Advantages and features of the disclosed embodiments and methods of accomplishing the same will be apparent by referring to embodiments described below in connection with the accompanying drawings. However, the present disclosure is not limited to the embodiments disclosed below, and may be implemented in various different forms, and the embodiments are merely provided to make the present disclosure complete, and to fully disclose the scope of the invention to those skilled in the art to which the present disclosure pertains.

The terms used herein will be briefly described prior to describing the disclosed embodiments in detail.

The terms used herein have been selected as general terms which are widely used at present in consideration of the functions of the present disclosure, and this may be altered according to the intent of an operator skilled in the art, conventional practice, or introduction of new technology. In addition, in a specific case, a term is arbitrarily selected by the applicant, and the meaning of the term will be described in detail in a corresponding description of the embodiments. Therefore, the terms used in the present disclosure should be defined based on the meaning of the terms and the overall contents of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms.

Further, throughout the description, when a portion is stated as “comprising (including)” a component, it intends to mean that the portion may additionally comprise (or include or have) another component, rather than excluding the same, unless specified to the contrary.

Furthermore, the term “unit” or “module” used herein denotes a software or hardware component, and the “unit” or “module” performs certain roles. However, the meaning of the “unit” or “module” is not limited to software or hardware. The “unit” or “module” may be configured to be in an addressable storage medium or configured to execute one or more processors. Accordingly, as an example, the “unit” or “module” may include components such as software components, object-oriented software components, class components, and task components, and at least one of processes, functions, attributes, procedures, subroutines, program code segments of program code, drivers, firmware, micro-codes, circuits, data, database, data structures, tables, arrays, and variables. Furthermore, functions provided in the components and the “units” or “module” may be combined as a smaller number of components and “units” or “module”, or further divided into additional components and “units” or “module”.

According to an embodiment, the “unit” or “module” may be implemented as a processor and a memory. The term “processor” should be interpreted broadly to encompass a general-purpose processor, a central processing unit (CPU), a microprocessor, a digital signal processor (DSP), a controller, a microcontroller, a state machine, and the like. Under some circumstances, a “processor” may refer to an application-specific integrated circuit (ASIC), a programmable logic device (PLD), a field-programmable gate array (FPGA), and the like. The term “processor” may refer to a combination of processing devices, e.g., a combination of a DSP and a microprocessor, a plurality of microprocessors, one or more microprocessors in conjunction with a DSP core, or any other combination of such configurations.

The term “memory” should be interpreted broadly to encompass any electronic component capable of storing electronic information. The term “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and the like. The memory is said to be in electronic communication with a processor if the processor can read information from and/or write information to the memory. The memory that is integral to a processor is in electronic communication with the processor.

In the present disclosure, the “user terminal” may be any electronic device (e.g., a smartphone, a PC, a tablet PC) or the like that is provided with a communication module to be capable of accessing a server or system through a network connection and is also capable of outputting or displaying an image. The user may input any command for image processing such as bokeh effect of the image through an interface of the user terminal (e.g., touch display, keyboard, mouse, touch pen or stylus, microphone, motion recognition sensor).

In the present disclosure, the “system” may refer to at least one of a server device and a cloud server device, but is not limited thereto.

In addition, “image” refers to an image that includes one or more pixels, and when the entire image is divided into a plurality of local patches, may refer to one or more divided local patches. In addition, “image” may refer to one or more images.

In addition, “receiving an image” may include receiving an image photographed and acquired from an image sensor attached to the same device. According to another embodiment, “receiving an image” may include receiving an image from an external device through a wired or wireless communication device or receiving the same transmitted from a storage device.

In addition, “depth map” refers to a set of numeric values or numbers that represent or characterize the depth of pixels in an image, such that, for example, the depth map may be expressed in the form of a matrix or vector of a plurality of numbers representing depth. In addition, the term “bokeh effect” may refer to any aesthetic effect or effect that is pleasing to the eye applied on at least a portion of an image. For example, the bokeh effect may refer to an effect generated by de-focusing an out-of-focus part and/or an effect generated by emphasizing, highlighting, or in-focusing an out-of-focus part. Furthermore, the “bokeh effect” may refer to a filter effect or any effect that may be applied to an image. Hereinafter, exemplary embodiments will be fully described with reference to the accompanying drawings in such a way that those skilled in the art can easily carry out the embodiments. Further, in order to clearly illustrate the present disclosure, parts not related to the description are omitted in the drawings.

The computer vision technology is a technology that performs the same functions as the human eye through a computing device, and may refer to a technology in which the computing device analyzes an image input from an image sensor and generates useful information such as objects and/or environmental characteristics in the image. Machine learning using artificial neural networks may be performed through any computing system implemented based on neural networks of human or animal brains, and as one of the detailed methodologies of the machine learning, it may refer to machine learning using the form of a network in which multiple neurons, which are nerve cells, are connected to each other.

According to some embodiments, the depth map may be corrected using a segmentation mask corresponding to the object in the image, so that errors that may occur in a result output through the trained artificial neural network model are corrected so as to more clearly distinguish the object (e.g., subject, background, and the like.) in the image, and more effective bokeh effect can be obtained. Furthermore, according to some embodiments, since the bokeh effect is applied based on the difference in depth inside the subject which is a single object, it is also possible to apply the bokeh effect in the subject which is a single object.

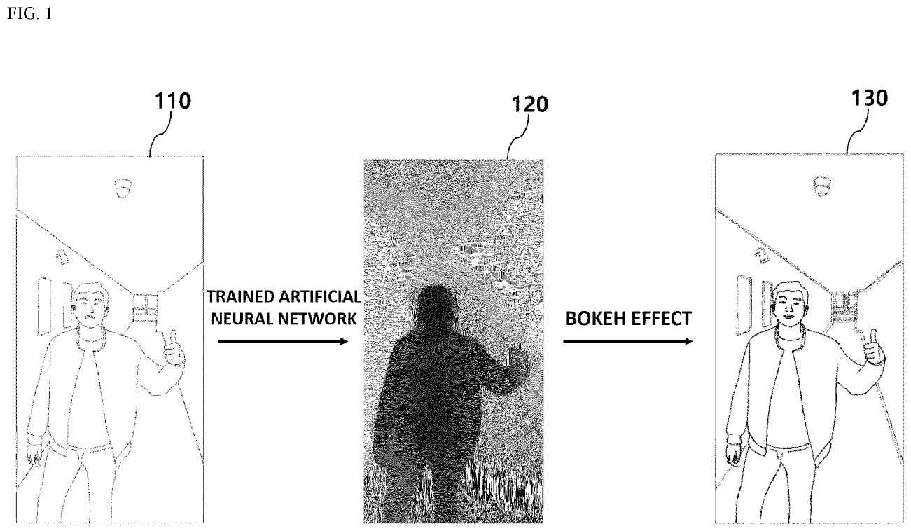

FIG. 1 is an exemplary diagram showing a process of generating a depth map from an image and applying a bokeh effect based on the same, at a user terminal according to an embodiment. As shown in FIG. 1, the user terminal may generate an image 130 from the original image 110 by applying a bokeh effect thereto. The user terminal may receive the original image 110 and apply the bokeh effect to the received original image. For example, the user terminal may receive the image 110 including a plurality of objects and generate the image 130 with the bokeh effect applied thereto, by focusing on a specific object (e.g., person) and applying an out-of-focus effect to the remaining objects (In this example, background) other than the person. In an example, the out-of-focus effect may refer to blurring a region or processing some pixels to appear hazy, but is not limited thereto.

The original image 110 may include an image file composed of pixels in which each of the pixels has information. According to an embodiment, the image 110 may be a single RGB image. The “RGB image” as used herein is an image formed of values of red (R), green (G), and blue (B) for each pixel, for example, between 0 and 255. A “single” RGB image is an image distinguished from an RGB image acquired from an image sensor where there are two or more lenses, and may refer to an image photographed from one image sensor. In this embodiment, the image 110 has been described as an RGB image, but is not limited thereto, and may refer to an image of various known formats.

In an embodiment, a depth map may be used in applying a bokeh effect to an image. For example, the bokeh effect may be applied by blurring a part with a deep depth in the image, while leaving a part with a shallow depth as it is or applying a highlight effect thereto. In an example, the height of the depth between pixels or regions in the image may be determined by setting the depth of a specific pixel or region as reference depth(s) and determining relative depths with the other pixels or regions.

According to an embodiment, the depth map may be a kind of image file. The depth may indicate the depth in the image, for example, a distance from the lens of the image sensor to the object represented by each pixel. Although the depth camera is commonly used to acquire the depth map, since the depth camera itself is expensive and few have been applied for use with portable terminals, conventionally, there is a limit to applying the bokeh effect using the depth map on a portable terminal.

According to an embodiment, the method for generating the depth map 120 may involve inputting the image 110 to the trained artificial neural network model as an input variable to generate the depth map. According to an embodiment, the depth map 120 may be generated from the image 110 by using an artificial neural network model, and the image 130 with the bokeh effect applied thereto may be generated based on the same. The depth, that is, the depth of the objects in the image from the image may be acquired through the trained artificial neural network model. When applying the bokeh effect using the depth map, the bokeh effect may be applied according to a certain rule or may be applied according to information received from a user. In FIG. 1, the depth map 120 is represented as a grayscale image, but this is an example for showing the difference between the depth of each pixel, and the depth map may be represented as a set of numeric values or numbers that represent or characterize the depth of pixels in the image.

Since the bokeh effect is applied based on depth information of the depth map generated using the trained artificial neural network model, a dramatic bokeh effect may be applied to an image photographed from entry-level equipment, such as a smartphone camera, for example, without the need for the depth camera or infrared sensor that requires expensive equipment. In addition, the bokeh effect may not be applied at the time of photographing, but may be applied afterwards to a stored image file, for example, an RGB image file.

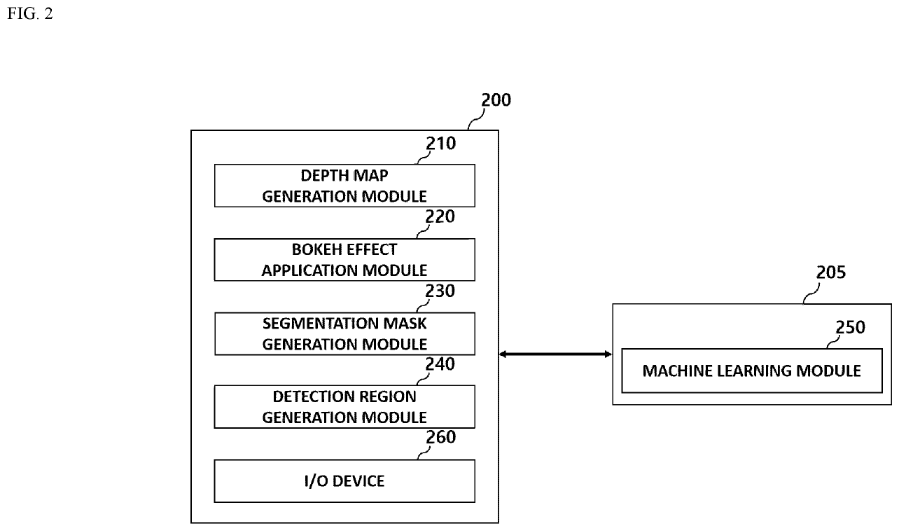

FIG. 2 is a block diagram showing a configuration of a user terminal 200 according to an embodiment. According to an embodiment, the user terminal 200 may be configured to include a depth map generation module 210, a bokeh effect application module 220, a segmentation mask generation module 230, a detection region generation module 240, and an I/O device 260. In addition, the user terminal 200 may be configured to be capable of communicating with the bokeh effect application system 205, and provided with a trained artificial neural network model including a first artificial neural network model, a second artificial neural network model, and a third artificial neural network model, which will be described below, which are trained in advance through a machine learning module 250 of the bokeh effect application system 205. As shown in FIG. 2, the machine learning module 250 is included in the bokeh effect application system 205, but embodiment is not limited thereto, and the machine learning module 250 may be included in the user terminal.

The depth map generation module 210 may be configured to receive an image photographed from the image sensor and generate a depth map based on the same. According to an embodiment, this image may be provided to the depth map generation module 210 immediately after being photographed from the image sensor. According to another embodiment, the image photographed from the image sensor may be stored in a storage medium that is included in the user terminal 200 or that is accessible, and the user terminal 200 may access the storage medium to receive the stored image when generating a depth map.

According to an embodiment, the depth map generation module 210 may be configured to generate a depth map by inputting the received image to the trained first artificial neural network model as an input variable. This first artificial neural network model may be trained through the machine learning module 250. For example, it may receive a plurality of reference images as input variables and trained to infer depth for each pixel or for each pixel group that includes a plurality of pixels. In this process, a reference image including depth map information corresponding to a reference image measured through a separate device (e.g., depth camera) may be used for the training so as to reduce the error in the depth map output through the first artificial neural network model.

The depth map generation module 210 may acquire, from the image 110, depth information included in the image through the trained first artificial neural network model. According to an embodiment, the depth information may be respectively assigned to every pixel in the image, may be assigned to every group of several adjacent pixels, or a same value may be assigned to several adjacent pixels.

The depth map generation module 210 may be configured to generate the depth map corresponding to the image in real time. The depth map generation module 210 may correct the depth map in real time by using a segmentation mask generated by the segmentation mask generation module 230. The depth map may not be implemented in real time, but the depth map generation module 210 may still generate a plurality of blur images in which the bokeh blur is applied with different intensity (e.g., kernel size). For example, the depth map generation module 210 may renormalize a previously generated depth map and interpolate the previously generated blur images that are blurred with different intensities according to the values of the renormalized depth map to implement an effect of varying the bokeh intensity in real time. For example, in response to a user input through an input device such as a touch screen that continuously changes the focus of the depth map by moving the progress bar or zooming with two fingers, the effect of correcting the depth map or changing the bokeh intensity in real time may be applied to the image.

The depth map generation module 210 may receive the RGB image photographed by the RGB camera and the depth image photographed from the depth camera, and match the depth image to the RGB image using a given camera variable or the like to generate the depth image aligned with the RGB image. Then, the depth map generation module 210 may derive a region in the generated depth image where there are points having a lower confidence level than a preset value and points having holes generated. In addition, the depth map generation module 210 may derive the depth estimation image from the RGB image by using an artificial neural network model (for example, first artificial neural network model) that is trained to derive an estimated depth map from the RGB image. The depth information about the points in the image where the confidence level is lower than the preset value and the points where the holes are generated may be estimated using the depth estimation image, and the estimated depth information may be input to the depth image to derive a completed depth image. For example, the depth information about the points where the confidence level of the image is lower than the preset value and the points where the holes are generated may be estimated using bilinear interpolation, histogram matching, and the previously trained artificial neural network model. In addition, this depth information may be estimated by using a median of values obtained using this method or a value derived by a weighted arithmetic mean to which a preset ratio is applied. When the estimated depth image is smaller than the required height and width, it may be upscaled to a required size using the previously trained artificial neural network model.

The bokeh effect application module 220 may be configured to apply a bokeh effect to pixels in the image based on the depth information about the pixels in the image corresponding to the depth map. According to an embodiment, the intensity of the bokeh effect to be applied may be designated with a predetermined function by using the depth as a variable. The predetermined function as used herein may be the function to vary the degree and shape of the bokeh effect by using a depth value as a variable. According to another embodiment, the depth sections may be divided and the bokeh effect may be provided discontinuously. In still another embodiment, the following effects or one or more combinations of the following effects may be applied according to the depth information of the extracted depth map.
1. The bokeh effect of different intensities is applied according to the depth value.
2. Different filter effects are applied according to the depth value.
3. A different background is substituted according to the depth value.

For example, the depth information may be set to 0 for the nearest object and 100 for the farthest object, and furthermore, a photo filter effect may be applied to section 0 to 20, an out-of-focus effect may be applied to section 20 to 40, and the background may be substituted in section 40 or more. In addition, a stronger out-of-focus effect (e.g., gradation effect) may be applied as the distance increases based on a mask selected from among one or more segmentation masks. According to still another embodiment, various bokeh effects may be applied according to setting information on applying bokeh effect input from the user.

The bokeh effect application module 220 may generate the bokeh effect by applying the previously selected filter to the input image using the depth information in the depth map. According to an embodiment, after the input image is reduced to fit a predetermined size (height×width), in order to improve processing speed and save memory, a previously selected filter may be applied to the reduced input image. For example, for the filtered images and depth maps, the symbol value corresponding to each pixel of the input image is calculated using the bilinear interpolation, and the pixel values may be calculated from the filtered images or input images corresponding to a region of the calculated numeric values using the bilinear interpolation as well. When the bokeh effect is applied to a specific region for the object regions in the image, the depth value of the corresponding region may be changed so that the estimated depth value in the depth map calculated for the object segmentation mask region of the specific region falls within a given numerical range, and then the image may be reduced and the pixel value may be calculated using bilinear interpolation.

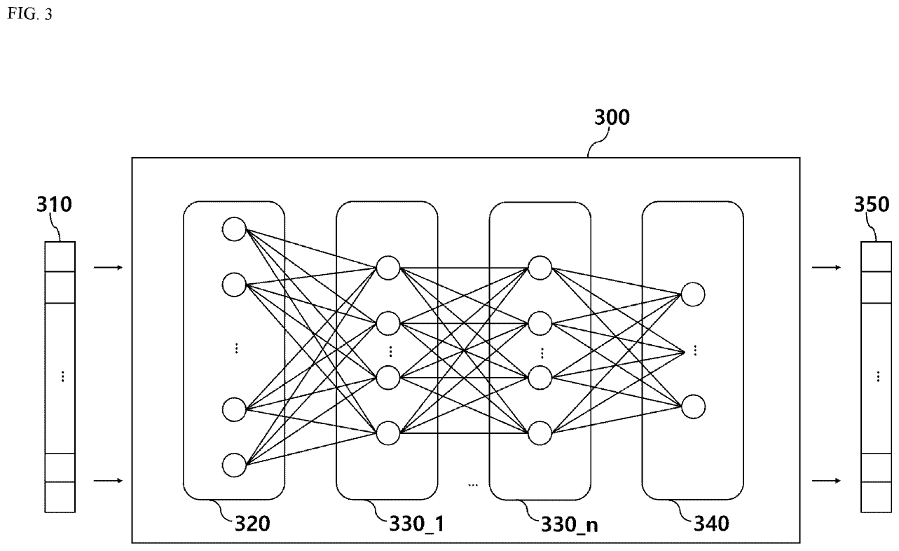

The segmentation mask generation module 230 may generate a segmentation mask for the object in an image, that is, may generate a segmented image region. In an embodiment, the segmentation mask may be generated by segmenting pixels corresponding to the object in the image. For example, image segmentation may refer to a process of dividing a received image into a plurality of pixel sets. The image segmentation is to simplify or transform the representation of an image into something more meaningful and easy to interpret, and is used to find an object or boundary (line, curve) corresponding to the object in the image, for example. One or more segmentation masks may be generated in the image. As an example, semantic segmentation is a technique for extracting a boundary of a specific thing, person, and the like with the computer vision technology, and refers to obtaining a mask of the person region, for example. As another example, instance segmentation is a technique of extracting a boundary of a specific thing, person, and the like for each instance with the computer vision technology, and refers to obtaining a mask of the person region for each person, for example. In an embodiment, the segmentation mask generation module 230 may use any technique already known in the segmentation technology field, and for example, may generate a segmentation mask for one or more objects in the image using mapping algorithms such as thresholding methods, argmax methods, histogram-based methods, region growing methods, split-and-merge methods, graph partitioning methods, and the like, and/or a trained artificial neural network model, although not limited thereto. In an example, the trained artificial neural network model may be a second artificial neural network model, and may be trained by the machine learning module 250. The learning process of the second artificial neural network model will be described in detail with reference to FIG. 3.

The depth map generation module 210 may be further configured to correct the depth map using the generated segmentation mask. When the segmentation mask is generated and used while the user terminal 200 provides the bokeh effect, it is possible to correct an inaccurate depth map or set reference depth(s) to apply the bokeh effect. In addition, it may be also possible to generate a precise depth map and apply a specialized bokeh effect by inputting the segmentation mask into the trained artificial neural network model. In an example, the trained artificial neural network model may be a third artificial neural network model, and may be trained by the machine learning module 250. The learning process of the third artificial neural network model will be described in detail with reference to FIG. 3.

The detection region generation module 240 may be configured to detect the object in the image and generate this into a specific region for the detected object. In an embodiment, the detection region generation module 240 may identify the object in the image and schematically generate the region. For example, it may detect the person in the image 110, and separate the corresponding region into a rectangular shape. One or more detection regions may be generated according to the number of objects in the image region. A method for detecting the object from the image may include RapidCheck, Histogram of Oriented Gradient (HOG), Cascade HOG, ChnFtrs, a part-based model, and/or a trained artificial neural network model, but is not limited thereto. When the detection region is generated through the detection region generation module 240 and the segmentation mask is generated in the detection region, thus defining and clarifying the object from which the boundary is to be extracted, the load on the computing device for extracting the boundary may be reduced, and the time for generating the mask may be shortened, and a more detailed segmentation mask may be acquired. For example, it may be more effective to define the region of the person and extract a mask for the region of the person than to command to extract a mask for the region of the person from the entire image.

According to an embodiment, the detection region generation module 240 may be configured to detect an object in the input image using a pre-trained object detection artificial neural network for the input image. The object may be segmented within the detected object region by using a pre-trained object segmentation artificial neural network for the detected object region. The detection region generation module 240 may derive the smallest region that includes the segmented object segmentation mask as the detection region. For example, the smallest region that includes the segmented object segmentation mask may be derived as a rectangular region. The region thus derived may be output in the input image.

The I/O device 260 may be configured to receive from a device user the setting information on the bokeh effect to be applied, or to output or display the original image and/or the image subjected to image processing. For example, the I/O device 260 may be a touch screen, a mouse, a keyboard, a display, and so on, but is not limited thereto. According to an embodiment, information for selecting a mask to apply highlighting may be received from a plurality of segmentation masks. According to another embodiment, it may be configured such that a touch gesture is received through a touch screen, which is an input device, and gradual and various bokeh effects are applied according to the information. In an example, the touch gesture may refer to any act of touching on the touch screen, which is an input device, with the user's finger, and for example, the touch gesture may refer to an act such as a long touch, sliding on a screen, a pinch in or out on the screen with a plurality of fingers, or the like. It may be configured such that the user may be enabled to set which bokeh effect is to be applied, according to the received information on applying bokeh effect, and it may be stored within a module, for example, within the bokeh effect application module 220. In an embodiment, the I/O device 260 may include any display device that outputs the original image or displays the image subjected to image processing such as the bokeh effect. For example, any display device may include a touch-panel display capable of touch inputting.

FIG. 2 shows that the I/O device 260 is included in the user terminal 200, but is not limited thereto, and the user terminal 200 may receive, through a separate input device, the setting information on bokeh effect to be applied or may output an image with the bokeh effect applied thereto through a separate output device.

The user terminal 200 may be configured to correct distortion of the object in the image.

According to an embodiment, when an image including the person face is photographed, the barrel distortion phenomenon that may occur due to a parabolic surface of a lens having a curvature may be corrected. For example, when the person is photographed near the lens, a lens distortion can cause the person's nose to appear relatively larger than other parts and the central region of the lens distorted like a convex lens can cause the person face to be photographed differently from the actual face. Accordingly, in order to correct this, the user terminal 200 may recognize an object (e.g., person face) in the image three-dimensionally and correct the image so that the object identical or similar to the actual object is included. In this case, the ear region which is initially hidden in the face of the person may be generated using a generative model such as deep learning GAN. Conversely, not only the deep learning technique, but also any technique that can naturally attach a hidden region to an object may be adopted.

The user terminal 200 may be configured to blend hair or hair color included in any object in the image. The segmentation mask generation module 230 may generate a segmentation mask corresponding to the hair region from the input image by using an artificial neural network that is trained to derive the hair region from the input image that includes the person, animal, or the like. In addition, the bokeh effect application module 220 may change the color space of the region corresponding to the segmentation mask into black and white and generate a histogram of the brightness of the changed black and white region. In addition, sample hair colors having various brightness may be prepared and stored in advance, allowing changes to be made as desired. The bokeh effect application module 220 may change the color space for the sample hair color to black and white and generate a histogram of the brightness of the changed black and white region. In this case, histogram matching may be performed such that similar colors may be selected or applied to the region having the same brightness. The bokeh effect application module 220 may substitute the matched color into the region corresponding to the segmentation mask.

FIG. 3 is a schematic diagram showing a method for training an artificial neural network model 300 by the machine learning module 250 according to an embodiment. In machine learning technology and cognitive science, the artificial neural network model 300 refers to a statistical training algorithm implemented based on a structure of a biological neural network, or to a structure that executes such algorithm. According to an embodiment, the artificial neural network model 300 may represent a machine learning model that acquires a problem solving ability by repeatedly adjusting the weights of synapses by the nodes that are artificial neurons forming the network through synaptic combinations as in the biological neural networks, thus training to reduce errors between a target output corresponding to a specific input and a deduced output. For example, the artificial neural network model 300 may include any probability model, neural network model, and the like, that is used in artificial intelligence learning methods such as machine learning and deep learning.

In addition, the artificial neural network model 300 may refer to any artificial neural network model or artificial neural network described herein, including the first artificial neural network model, the second artificial neural network model, and/or the third artificial neural network model.

The artificial neural network model 300 is implemented as a multilayer perceptron (MLP) formed of multiple nodes and connections between them. The artificial neural network model 300 according to an embodiment may be implemented using one of various artificial neural network model structures including the MLP. As shown in FIG. 3, the artificial neural network model 300 includes an input layer 320 receiving an input signal or data 310 from the outside, an output layer 340 outputting an output signal or data 350 corresponding to the input data, and (n) number of hidden layers 330_1 to 330_n (where n is a positive integer) positioned between the input layer 320 and the output layer 340 to receive a signal from the input layer 320, extract the features, and transmit the features to the output layer 340. In an example, the output layer 340 receives signals from the hidden layers 330_1 to 330_n and outputs them to the outside.

The training method of the artificial neural network model 300 includes a supervised learning that trains for optimization for solving a problem with inputs of teacher signals (correct answer), and an unsupervised learning that does not require a teacher signal. In order to provide the depth information of the object such as a subject and a background in the received image, the machine learning module 250 may analyze the input image by using supervised learning and train the artificial neural network model 300, that is, the first artificial neural network model, so that the depth information corresponding to the image may be extracted. In response to the received image, the artificial neural network model 300 trained as described above may generate a depth map including the depth information and provide it to the depth map generation module 210, and provide a basis for the bokeh effect application module 220 to apply the bokeh effect to the received image.

According to an embodiment, as shown in FIG. 3, an input variable of the artificial neural network model 300 that can extract depth information, that is, the first artificial neural network model, may be an image. For example, the input variable input to the input layer 320 of the artificial neural network model 300 may be an image vector 310 that includes the image as one vector data element.

Meanwhile, an output variable output from the output layer 340 of the artificial neural network model 300, that is, from the first artificial neural network model, may be a vector representing the depth map. According to an embodiment, the output variable may be configured as a depth map vector 350. For example, the depth map vector 350 may include the depth information of the pixels of the image as the data element. In the present disclosure, the output variable of the artificial neural network model 300 is not limited to those types described above, and may be represented in various forms related to the depth map.

As described above, the input layer 320 and the output layer 340 of the artificial neural network model 300 are respectively matched with a plurality of output variables corresponding to a plurality of input variables, so as to adjust the synaptic values between nodes included in the input layer 320, the hidden layers 330_1 to 330_n, and the output layer 340, thereby training to extract the correct output corresponding to a specific input. Through this training process, the features hidden in the input variables of the artificial neural network model 300 may be confirmed, and the synaptic values (or weights) between the nodes of the artificial neural network model 300 may be adjusted so as to reduce the errors between the output variable calculated based on the input variable and the target output. By using the artificial neural network model 300 trained as described above, that is, by using the first artificial neural network model, the depth map 350 in the received image may be generated in response to the input image.

According to another embodiment, the machine learning module 250 may receive a plurality of reference images as the input variables of the input layer 310 of the artificial neural network model 300, that is, the second artificial neural network model, and be trained such that the output variable output from the output layer 340 of the second artificial neural network model may be a vector representing a segmentation mask for object included in a plurality of images. The second artificial neural network model trained as described above may be provided to the segmentation mask generation module 230.

According to another embodiment, the machine learning module 250 may receive some of a plurality of reference images, for example, a plurality of reference segmentation masks as the input variables of the input layer 310 of the artificial neural network model 300, that is, the third artificial neural network model. For example, the input variable of the third artificial neural network model may be a segmentation mask vector that includes each of the plurality of reference segmentation masks as one vector data element. In addition, the machine learning module 250 may train the third artificial neural network model so that the output variable output from the output layer 340 of the third artificial neural network model may be a vector representing precise depth information of the segmentation mask. The trained third artificial neural network model may be provided to the bokeh effect application module 220 and used to apply a more precise bokeh effect to a specific object in the image.

In an embodiment, the range [0, 1] used in the related artificial neural network model can be calculated by dividing by 255. Conversely, the artificial neural network model according to the present disclosure may include a range [0, 255/256] calculated by dividing by 256. This may also be applied when the artificial neural network model is trained Generalizing this and normalizing the input may adopt a method of dividing by the power of 2. According to this technique, the use of the power of 2 when training the artificial neural network may minimize the computational amount of the computer architecture during multiplication/division, and such computation can be accelerated.

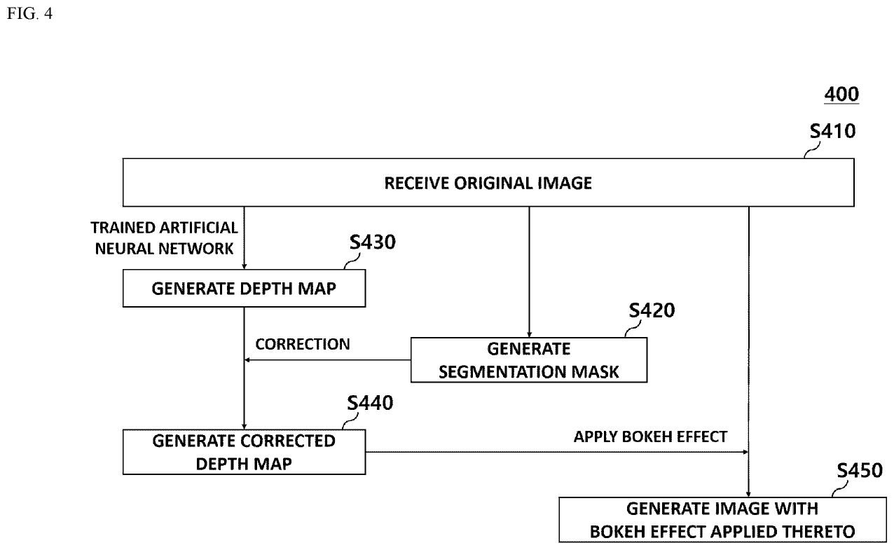

FIG. 4 is a flowchart showing a method of the user terminal 200 for correcting the depth map based on the segmentation mask generated from the image and applying the bokeh effect using the corrected depth map according to an embodiment.

The method 400 for applying the bokeh effect may include receiving an original image by the depth map generation module 210, at S410. The user terminal 200 may be configured to receive an image photographed from the image sensor. According to an embodiment, the image sensor may be included in the user terminal 200 or mounted on an accessible device, and the photographed image may be provided to the user terminal 200 or stored in a storage device.

When the photographed image is stored in the storage device, the user terminal 200 may be configured to access the storage device and receive the image. In this case, the storage device may be included together with the user terminal 200 as one device, or connected to the user terminal 200 as a separate device by wired or wirelessly.

The segmentation mask generation module 230 may generate the segmentation mask for the object in the image, at S420. According to an embodiment, when using the deep learning technique, the segmentation mask generation module 230 may acquire a 2D map having a probability value for each class as a result value of the artificial neural network model, and generate a segmentation mask map by applying thresholding or argmax thereto such that a segmentation mask may be generated. When the deep learning technique is used, by providing various images as the input variables of the artificial neural network learning model, the artificial neural network model may be trained to generate a segmentation mask of the object included in each image, and the segmentation mask of the object in the image received through the trained artificial neural network model may be extracted.

The segmentation mask generation module 230 may be configured to generate the segmentation mask by calculating segmentation prior information of the image through the trained artificial neural network model. According to an embodiment, the input image may be preprocessed to satisfy the data characteristics required by a given artificial neural network model before being input into the artificial neural network model. In an example, the data characteristic may be a minimum value, a maximum value, an average value, a variance value, a standard deviation value, a histogram, and the like of specific data in the image, and may be processed together with or separately from the channel of input data (e.g., RGB channel or YUV channel) as necessary. For example, the segmentation prior information may refer to information indicating, by a numeric value, whether or not each pixel in the image is an object to be segmented, that is, whether it is a semantic object (e.g., person, object, and the like). For example, through quantization, the segmentation prior information may represent the numeric value corresponding to the prior information of each pixel in the form of a value between 0 and 1. In an example, it may be determined that a value closer to 0 is more likely to be a background, and a value closer to 1 is more likely to correspond to the object to be segmented. During this operation, the segmentation mask generation module 230 may set the final segmentation prior information to 0 (background) or 1 (object) for each pixel or for each group that includes a plurality of pixels, using a predetermined specific threshold value. In addition, the segmentation mask generation module 230 may determine a confidence level for the segmentation prior information of each pixel or each pixel group that includes a plurality of pixels, in consideration of the distribution, numeric values, and the like of the segmentation prior information corresponding to the pixels in the image, and use the segmentation prior information and confidence level for each pixel or each pixel group when setting the final segmentation prior information. Then, the segmentation mask generation module 230 may generate a segmentation mask for the pixels having a value of 1. For example, when there are a plurality of meaningful objects in the image, segmentation mask 1 may represent object 1, . . . , and segmentation mask n may represent object n (where n is a positive number equal to or greater than 2). Through this process, a map having a value of 1 for the segmentation mask region corresponding to meaningful object in the image and a value of 0 for the outer region of the mask may be generated. For example, during this operation, the segmentation mask generation module 230 may discriminately generate the image for each object or the background image by computing a product of the received image and the generated segmentation mask map.

According to another embodiment, it may be configured such that, before generating the segmentation mask corresponding to the object in the image, a detection region that detected the object included in the image may be generated. The detection region generation module 240 may identify the object in the image 110 and schematically generate the region of the object. Then, the segmentation mask generation module 230 may be configured to generate a segmentation mask for the object in the generated detection region. For example, it may detect the person in the image and separate the region into a rectangular shape. Then, the segmentation mask generation module 230 may extract the region corresponding to the person in the detection region. Since the object and the region corresponding to the object are defined by detecting the object included in the image, speed of generating the segmentation mask corresponding to the object may be increased, accuracy may be increased, and/or the load of a computing device performing the task may be reduced.

The depth map generation module 210 may generate a depth map of the image using the pre-trained artificial neural network model, at S430. In an example, as mentioned in FIG. 3, the artificial neural network model may receive a plurality of reference images as input variables and trained to infer depth for each pixel or for each pixel group that includes a plurality of pixels. According to an embodiment, the depth map generation module 210 may input the image into the artificial neural network model as the input variable to generate a depth map having depth information on each pixel or the pixel group that includes a plurality of pixels in the image. The resolution of the depth map 120 may be the same as or lower than that of the image 110, and when the resolution is lower than that of the image 110, the depth of several pixels of the image 110 may be expressed as one pixel, that is, may be quantized. For example, it may be configured such that, when the resolution of the depth map 120 is ¼ of the image 110, one depth is applied per four pixels of the image 110. According to an embodiment, the generating the segmentation mask at S420 and the generating the depth map at S430 may be independently performed.

The depth map generation module 210 may receive the segmentation mask generated from the segmentation mask generation module 230 and correct the generated depth map by using the segmentation mask, at S440. According to an embodiment, the depth map generation module 210 may determine the pixels in the depth map corresponding to the segmentation mask to be one object, and correct the corresponding depth of the pixels. For example, when the deviation of the depth of the pixels of the region determined to be one object in the image is large, such deviation may be corrected to reduce the depth of the pixels in the object. As another example, when the person is standing at an angle, since the depth is different even in the same person, the bokeh effect may be applied to a certain region of the person, in which case the depth information about the pixels in the person may be corrected such that the bokeh effect is not applied to the pixels corresponding to the segmentation mask for the person. When the depth map is corrected, there is an effect that the error such as application of the out-of-focus effect on unwanted region can be reduced, and the bokeh effect can be applied to a more accurate region.

The bokeh effect application module 220 may generate an image which is a result of applying the bokeh effect to the received image, S450. In an example, the bokeh effect including various bokeh effects described with reference to the bokeh effect application module 220 of FIG. 2 may be applied. According to an embodiment, the bokeh effect may be applied to a pixel or a group of pixels corresponding to the depth based on the depth in the image, while applying a stronger out-of-focus effect on the outer region of the mask, and applying a relatively weaker effect on the mask region compared to the outer region or may not apply a bokeh effect at all.

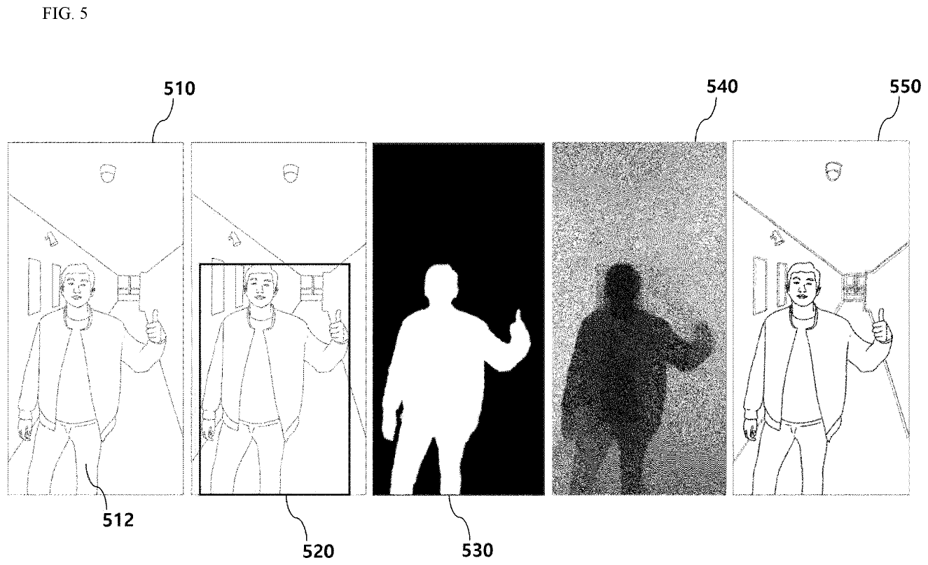

FIG. 5 is a schematic diagram showing a process of the user terminal 200 of generating a segmentation mask 530 for the person included in the image and applying the bokeh effect to the image based on a corrected depth map according to an embodiment. In this embodiment, the image 510 may be a photographed image of the person standing in the background of an indoor corridor, as shown in FIG. 5.

According to an embodiment, the detection region generation module 240 may receive the image 510 and detect the person 512 from the received image 510. For example, as shown, the detection region generation module 240 may generate a detection region 520 including the region of the person 512, in a rectangular shape.

Furthermore, the segmentation mask generation module 230 in the detection region may generate a segmentation mask 530 for the person 512 from the detection region 520. In an embodiment, the segmentation mask 530 is shown as a virtual region as white in FIG. 5, but is not limited thereto, and it may be represented as any indication or a set of numeric values indicating the region corresponding to the segmentation mask 530 on the image 510. For example, the segmentation mask 530 may include an inner region the object on the image 510, as shown in FIG. 5.

The depth map generation module 210 may generate a depth map 540 of the image representing depth information from the received image. According to an embodiment, the depth map generation module 210 may generate the depth map 540 using the trained artificial neural network model. For example, as shown, the depth information may be expressed such that nearby region is close to black and far region is close to white. Alternatively, the depth information may be expressed as numeric values, and may be expressed within the upper and lower limits of the depth value (e.g., 0 for the nearest region and 100 for the farthest region). In this process, the depth map generation module 210 may correct the depth map 540 based on the segmentation mask 530. For example, a certain depth may be applied to the person in the depth map 540 of FIG. 5. In an example, certain depth may represent an average value, a median value, a mode value, a minimum value, or a maximum value of the depth in the mask, or as the depth of a specific region, for example, of the tip of the nose, or the like.

The bokeh effect application module 220 may apply the bokeh effect to the region other than the person based on the depth map 540 and/or the corrected depth map (not shown). As shown in FIG. 5, the bokeh effect application module 220 may apply a blur effect to the region other than the person in the image to apply the out-of-focus effect. Conversely, the region corresponding to the person may not have any effect applied thereto or may be applied with the emphasis effect.

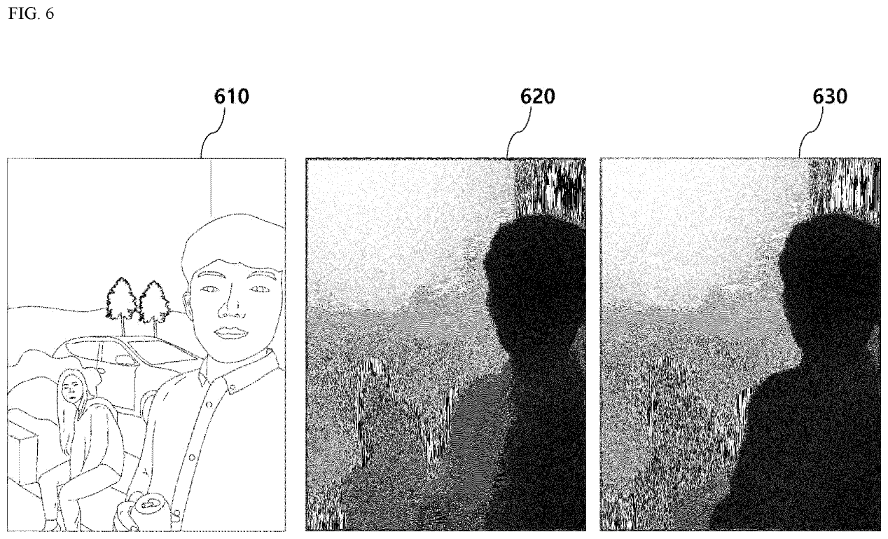

FIG. 6 is a comparison diagram shown by the user terminal 200 according to an embodiment, showing a comparison between a depth map 620 generated from an image 610 and a depth map 630 corrected based on a segmentation mask corresponding to the image 610. In an example, the image 610 may be a photographed image of a plurality of people near an outside parking lot.

According to an embodiment, as shown in FIG. 6, when the depth map 620 is generated from the image 610, even the same object may show a considerable depth deviation depending on position or posture. For example, the depth corresponding to the shoulders of the person standing at an angle may have a large difference from the average value of the depth corresponding to the person object. As shown in FIG. 6, in the depth map 620 generated from the image 610, the depth corresponding to the shoulders of the person on the right side is relatively larger than the other depth values in that person. When the bokeh effect is applied based on this depth map 620, even when the person on the right side in the image 610 is selected as the object for which in-focus is desired, a certain region of the person on the right side, for example, the right shoulder region may be out-of-focus.

To solve this problem, the depth information of the depth map 620 may be corrected by using the segmentation mask corresponding to the object in the image. For example, the correction may be to modify to the average value, the median value, the mode value, the minimum value, the maximum value, or the depth value of a specific region. This process may solve the problem that a certain region of the person on the right side in the depth map 620, that is, the right shoulder region of the person on the right side in the example of FIG. 6, are out-of-focus separately from the person on the right side. Different bokeh effect may be applied by discriminating the object into inner and outer regions of the object. The depth map generation module 210 may correct the depth corresponding to the object on which the user wants to apply the bokeh effect by using the generated segmentation mask, so that the bokeh effect that more correctly matches the user's intention and suits the user's intention may be applied. As another example, there may be a case in which the depth map generation module 210 does not accurately recognize a part of the object, and this can be improved by using the segmentation mask. For example, depth information may not be correctly identified for the handle of the cup placed at an angle, and in this case, the depth map generation module 210 may identify that the handle is a part of the cup using the segmentation mask and correct to acquire correct depth information.

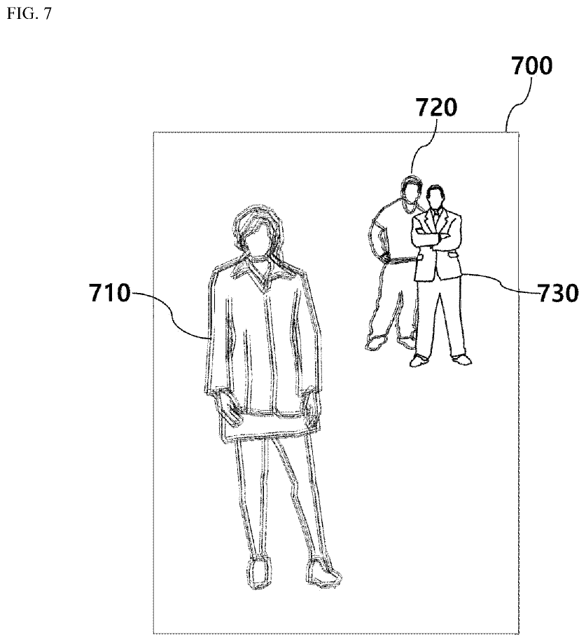

FIG. 7 is an exemplary diagram obtained as a result of, at the user terminal 200, determining a reference depth corresponding to a selected object in the image, calculating a difference between the reference depth and the depth of the other pixels, and applying the bokeh effect to the image 700 based on the same according to an embodiment. According to an embodiment, the bokeh effect application module 220 may be further configured to determine the reference depth corresponding to the selected object, calculate the difference between the reference depth and the depth of the other pixels in the image, and apply the bokeh effect to the image based on the calculated difference. In an example, the reference depth may be represented as the average value, the median value, the mode value, the minimum value, or the maximum value of the depths of the pixel values corresponding to the object, or as the depth of a specific region, for example, of the tip of the nose, or the like. For example, in the case of FIG. 7, the bokeh effect application module 220 may be configured to determine the reference depth for each of the depths corresponding to three people 710, 720, and 730, and apply the bokeh effect based on the determined reference depth. As shown, when the person 730 positioned in the middle in the image is selected to be in-focus, the out-of-focus effect may be applied to the other people 710 and 720.

According to an embodiment, the bokeh effect application module 220 may be configured to apply different bokeh effects according to a difference in relative depth between the reference depth of the selected object and the other pixels in the image. For example, when the person 730 positioned in the middle is selected to be in-focus, as shown, with reference to the person 730 positioned in the middle, the nearest person 710 is relatively farther apart than the farthest person 720, and accordingly, the bokeh effect application module 220 may process such that a stronger out-of-focus effect is applied to the nearest person 710 than the out-of-focus effect applied to the farthest person 720 in the image 700.

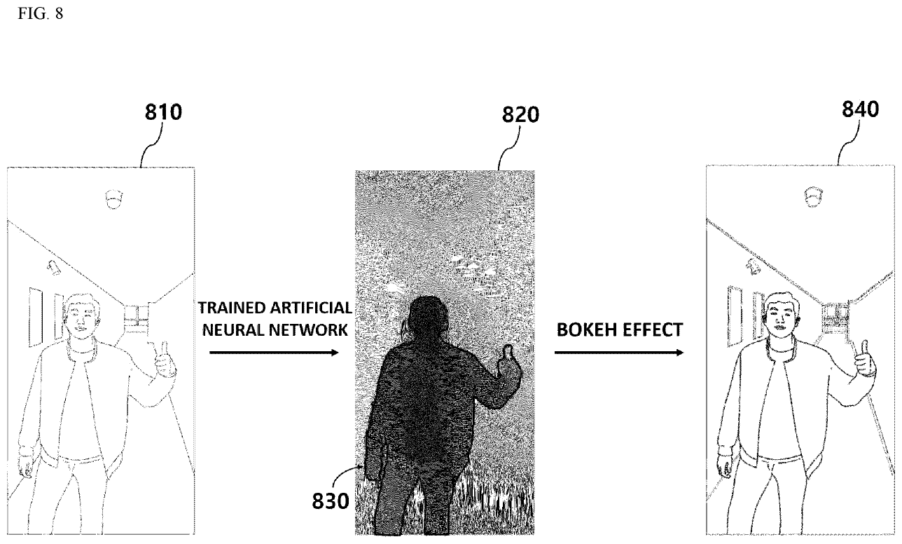

FIG. 8 is a schematic diagram showing a process of the user terminal 200 of generating a depth map 820 from an image 810, determining the object in the image, and applying the bokeh effect based on the same according to an embodiment. According to an embodiment, the depth map generation module 210 may be configured to determine at least one object 830 in the image 810 through the first artificial neural network model. The bokeh effect application module 220 may be further configured to determine a reference depth corresponding to the determined at least one object 830, calculate a difference between the reference depth and the depth of the other pixels in the image, and apply the bokeh effect to the image based on the calculated difference.

In an embodiment, the input variable of the artificial neural network model 300 from which depth information can be extracted, may be the image 810, and the output variable output from the output layer 340 of the artificial neural network model 300 may be a vector representing the depth map 820 and the determined at least one object 830. In an embodiment, the acquired object may be applied with a uniform depth. For example, the uniform depth may be expressed as an average value or the like of depths of pixels in the acquired object. In this case, an effect similar to that of generating a mask and using it can be obtained without a separate process of generating a segmentation mask. When correcting the acquired object with uniform depth, the depth map may be corrected to obtain a depth map more suitable for applying the bokeh effect.

In the method for applying the bokeh effect according to an embodiment, a similar bokeh effect can be applied while simplifying the procedure by omitting the process of generating the segmentation mask, so that the effect of improving the speed of the whole mechanism and reducing the load on the device can be achieved.

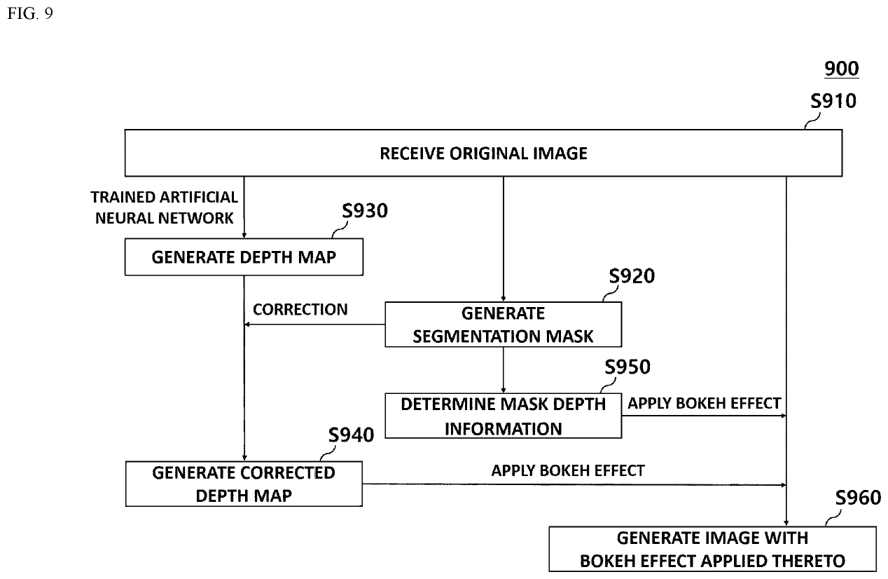

FIG. 9 is a flowchart showing a process of the user terminal 200 of generating the segmentation mask for the object included in the image, inputting the segmentation mask generated in the process of applying the bokeh effect as an input variable of a separate trained artificial neural network model, acquiring the depth information of the segmentation mask, and applying the bokeh effect to the image corresponding to the segmentation mask based on the same according to an embodiment. The operations at S910, S920, S930, and S940 included in the flowchart of FIG. 9 may include the same or similar operations as those at S410, S420, S430, and S440 included in the flowchart of FIG. 4. In FIG. 9, description that may overlap with those already described above in the flowchart of FIG. 4 will be omitted.

The depth map generation module 210 may be further configured to input the segmentation mask generated from the original image as an input variable to a separate trained artificial neural network model (for example, the third artificial neural network model) and determine precise depth information for the segmentation mask, at S950. According to an embodiment, the depth map generation module 210 may use an artificial neural network model specialized for a specific object, in addition to the artificial neural network that is commonly used for general images. For example, the third artificial neural network model may be trained to receive an image including the person and infer a depth map of the person or the person's face. In this process, in order to infer a more precise depth map, the third artificial neural network model may be subjected to supervised learning using a plurality of reference images including the person having a previously measured depth.

According to another embodiment, the depth map generation module 210 may use a method to obtain precise depth information about the object corresponding to the segmentation mask as described below. For example, precise depth information for the object corresponding to the segmentation mask may be generated using a depth camera such as a Time of Flight (TOF) or Structured light. As another example, depth information of the inside of the object (e.g., person) corresponding to the segmentation mask may be generated using a computer vision technology such as feature matching.

The bokeh effect application module 220 may be further configured to apply the bokeh effect to the original image based on the corrected depth map that corresponds to the original image generated at S930 and S940 and the precise depth information of the generated segmentation mask, at S960. By using the precise depth information corresponding to the segmentation, a more detailed and error-free bokeh effect can be applied to the inside of a specific object. According to an embodiment, the bokeh effect may be applied to the segmentation mask region using the depth information of the segmentation mask, and the bokeh effect may be applied to the region other than the segmentation mask using a depth map. In this process, a hybrid bokeh effect may be applied such that a specific segmentation mask region where the precise depth information is generated, for example, the person's face, may be applied with a very detailed bokeh effect, and the remaining segmentation region and the region other than the mask may be applied with a less detailed bokeh effect. Through this configuration, a high quality result can be acquired while minimizing the computing load of the user terminal. In FIG. 9, it is shown that the bokeh effect is applied using the depth map generated through S930 and S940 together with the mask depth information generated at S950, but is not limited thereto, and the bokeh effect may be applied at S960 by using the depth map generated at S930 and the mask depth information generated at S950 while skipping S940.

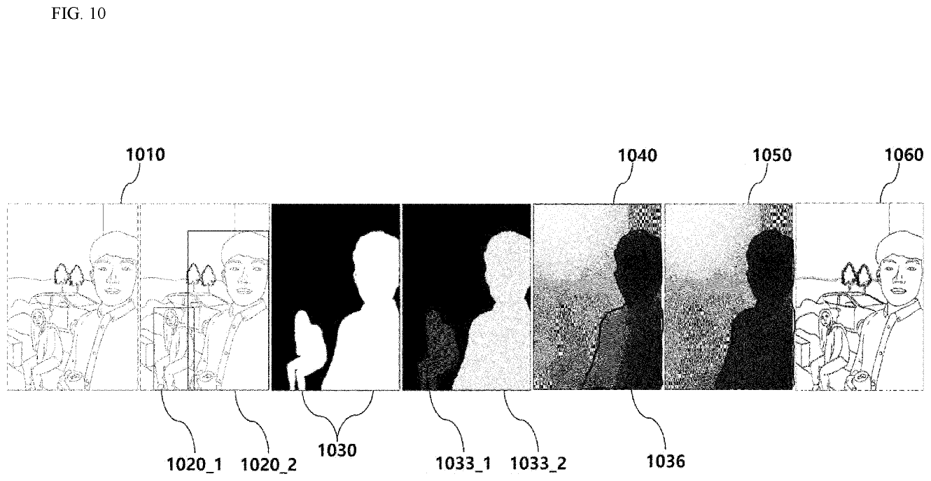

FIG. 10 is a schematic diagram showing a process of the user terminal 200 of generating a plurality of segmentation masks for a plurality of objects included in an image 1010, and applying the bokeh effect based on a mask selected from the same according to an embodiment. As shown in FIG. 10, the image 1010 may include a plurality of objects. According to an embodiment, the detection region generation module 240 may be further configured to generate a plurality of detection regions 1020_1 and 1020_2 each of which is detected from a plurality of objects included in the received image 1010. For example, as shown, the regions of the person on the left side and the person on the right side are detected as rectangles, respectively.

The segmentation mask generation module 230 may be configured to generate a segmentation mask 1030 for the object. According to an embodiment, the segmentation mask generation module 230 may be further configured to generate a plurality of segmentation masks 1033_1, 1033_2 for each (person on the left side, person on the right side) of a plurality of objects in each of a plurality of detection regions, as shown in FIG. 10.

The depth map generation module 210 may correct the depth map 1040 generated from the image 1010 through the generated segmentation mask, and in this process, rather than using the entire segmentation mask, at least one selected mask may be used for the correction. For example, as shown in FIG. 10, when the mask 1033_2 of the person on the right side is selected, a corrected depth map 1050 may be obtained using the mask. Alternatively, the depth map may be corrected using both the mask 1033_1 of the person on the left side and the mask 1033_2 of the person on the right side.

In an embodiment, in applying the bokeh effect to the image 1010, the bokeh effect application module 220 may apply the emphasis effect to he selected mask, or apply an out-of-focus effect to the remaining masks. Depending on which mask is selected, the out-of-focus may be applied to a different mask. In this process, the non-selected region of the mask may be treated similarly as a non-mask region. The image 1060 with the bokeh effect applied thereon in FIG. 10 may represent an image in which the mask 1033_2 of the person on the right side is selected such that the out-of-focus effect is applied except for the selected segmentation mask 1036. In an example, the mask 1033_1 of the person on the left side was detected and the object corresponding thereto was extracted, but the out-of-focus effect was applied. For example, when the mask 1033_1 of the person on the left side is selected, the out-of-focus effect may be applied to the mask region of the person on the right side.

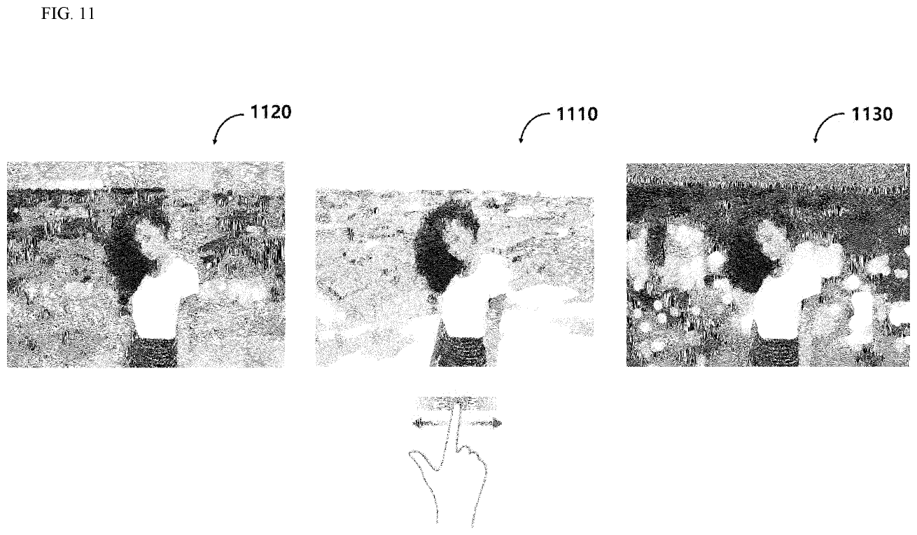

FIG. 11 is a schematic diagram showing a process of changing the bokeh effect according to the setting information on bokeh effect application received from the user terminal 200 according to an embodiment. According to an embodiment, the i/o device 260 may include a touch screen, and setting information on applying bokeh effect may be determined based on a touch input on the touch screen.

The i/o 260 of the user terminal 200 may be configured to receive the information for setting the bokeh effect to be applied. Also, the bokeh effect application module 220 may change the bokeh effect according to the received information and apply this to at least a part of the image. According to an embodiment, a pattern for applying bokeh effect, for example, an intensity or a shape of the bokeh may be changed, or various filters may be applied. For example, as shown in FIG. 10, a drag on the touch screen to the left may result in generation of an image 1120 which is the result of applying a first designated filter effect on the image 1110, and a drag to the right may result in generation of an image 1130 which is the result of applying a second designated filter to the image 1110, and a stronger bokeh effect may be applied as the degree of drag increases. According to another embodiment, a left-right drag may result in diversified out-of-focus effect in the region other than the mask, and an up-down drag may result in diversified in-focus effect in the mask region. The “diversification” herein includes various changes in visual effects such as varying filters or varying the shape of the bokeh, and is not limited to the embodiments described herein. It may be configured such that what kind of bokeh effect is to be applied according to a touch gesture such as drag or zoom-in/zoom-out may be set by the user, and may be stored in the bokeh effect application module 220.

According to an embodiment, the user terminal 200 may be configured to generate a segmentation mask for the object included in the received image. In addition, the user terminal 200 may display the background in the image and the object (e.g., person) included in the generated segmentation mask. Then, a touch input (for example, contact) is received through an input device such as a touch screen for the displayed image, and when the received touch input corresponds to a preset gesture, a graphic element may be substituted with another graphic element.

According to an embodiment, a left-right swipe may result in a change in the background or the filter for the background region in the image. In addition, an up-down swipe may result in substitution of the filter for the person region in the image. The result of changing the filter according to the left-right swipe and the up-down swipe may be interchanged. In addition, when a touch input in the image indicates a swipe-and-hold, the background in the image may be automatically and continuously changed. In addition, in the swipe motion, as the length of the swipe at the touch point is lengthened, the acceleration of the background substitution (filter substitution) may increase. Then, when it is determined that the touch input in the image is ceased, the background substitution in the image may be stopped. For example, it may be configured such that, when there are two or more graphic elements in the image, only one graphic element may be changed according to the touch input in the image, that is, according to one gesture.

According to another embodiment, when the received touch input corresponds to a preset gesture, the user terminal 200 may change only the person focused in the image. For example, the focused person may be changed by left-right swipe. As another example, when the segmented person is tapped, the person to be focused may be changed. As still another example, when the user terminal 200 receives a touch input corresponding to the tap on any region of the image, the person to be focused in the image may be changed in order. In addition, an area of the inside of the image may be calculated using face segmentation and instant segmentation in the image. In addition, it may be calculated how far the instant segmentation is away from the focused person. Based on this calculated value, the out-of-focus effect of different intensities for each person may be applied. Accordingly, since the user terminal 200 generates a segmentation mask corresponding to the object region, the region corresponding to the object in the image is known, and accordingly, the user is enabled to change the focusing of the object region by touching any region in the image and without touching the region corresponding to the object region in the image.

According to another embodiment, the user terminal 200 may calculate the area of the inside of the object (e.g., person) in the image by using the segmentation mask generated for one or more objects in the image. In addition, the number of people in the image may be calculated using the instance segmentation technique. An optimal filter may be applied through the calculated area of people and number of people. For example, the optimal filter may include a graphic element to be background-substituted, and a color filter that can change the atmosphere of the image, but is not limited thereto. According to this filter application, a user may smartly apply a photo filter effect to the image.

According to another embodiment, the user terminal 200 may display a location of the object (e.g., person) in the image by using a segmentation mask corresponding to one or more objects in the image. Accordingly, the user terminal 200 may display a graphic user interface (GUI) in which a computer graphic function is available in a region other than a location that corresponds to the displayed object in the image. When the image is a video, a GUI may be displayed so as not to block the person by tracking the location of the person in the frames in the image. For example, a subtitle may be displayed as a GUI in the region other than the person in the image.

According to another embodiment, the user terminal 200 may detect a user's touch input in the image through an input device such as a touch screen, and the contacted region in the image may be focused and the non-contacted region may be out-of-focus. The user terminal 200 may be configured to detect contact of two fingers of the user. For example, the user terminal 200 may detect a zoom-in and/or zoom-out motion of the two fingers in the image, and accordingly, adjust the intensity of the bokeh in the image. As such a zoom-in and/or zoom-out motion function is supported, the user terminal 200 may use a zoom-in and/or zoom-out motion as a method of adjusting the out-of-focus intensity, and the object to be out-of-focus in the image may be extracted by the segmentation mask corresponding to one or more objects in the image.

In an embodiment, the user terminal 200 may be configured to separate the hair object from the person object by using the segmentation mask corresponding to one or more objects in the image. Then, the user terminal 200 may provide a list of dyes to the user, receive one or more of them from the user, and apply a new color to the separated hair region. For example, the user may swipe a region of the person in the image such that a new color is applied to the hair region of the person. As another example, the user terminal 200 may receive a swipe input on the upper region of the hair region in the image, and accordingly, a color to be applied to the hair region may be selected. In addition, a swipe input may be received on a lower region of the hair region in the image, and accordingly, a color to be applied to the hair region may be selected. In addition, the user terminal 200 may select two colors according to swipe inputs input to the upper and lower regions of the hair region, and apply gradient dyeing to the hair region by combining the two selected colors. For example, a dyeing color may be selected and applied according to a current hair color displayed on the person region in the image. For example, the hair region displayed in the person region in the image may be a variety of dyed hair such as bleached hair, healthy hair, and dyed hair, and different dyeing colors may be applied according to the shape or color of the hair.

According to an embodiment, the user terminal 200 may be configured to separate the background and person regions from the received image. For example, the background and person regions may be separated within the image using the segmentation mask. First, the background region in the image may be out-of-focus. Then, the background may be substituted with another image, and various filter effects may be applied. For example, when detecting a swipe input in the background region in an image, a different background may be applied to the corresponding background region. In addition, lighting effects of different environments may be applied for each background on the person region and the hair region in the image. For example, the lighting effects of different environments may be applied for each background so as to show which colors can be seen in each region when viewed under different lighting. An image applied with the color, bokeh or filter effects may be output. Through this technique, the user may try an augmented reality (AR) experience, that is, may experience selecting a dyeing color at a beauty salon or a cosmetic shop, and virtually applying the dye on his or her hair in advance by using the segmentation technology. In addition, since the background and the person in the image are separated, various effects described above may be applied.

According to an embodiment, the user terminal 200 may be configured to track and automatically focus an object in an image touched by the user. The image may be separated into a plurality of graphic elements. For example, a method of separating into graphic elements may use an algorithm using an artificial neural network model, segmentation, and/or detection techniques, but is not limited thereto. Then, in response to receiving selection of at least one of the graphic elements from the user, the touched graphic element may be tracked and automatically focused. At the same time, the out-of-focus effect may be applied to the non-selected graphic element of the image. For example, in addition to the out-of-focus effect, other image conversion functions such as filter application and background substitution may be applied. Then, when another graphic element is touched, the focusing in the image may be changed with the touched graphic element.

In an embodiment, the user terminal 200 may generate a segmentation mask for each part of the person region from the input image by using an artificial neural network that is trained to derive the person region from the input image including the person. For example, the person part, although not limited thereto, may be divided into various parts such as hair, face, skin, eyes, nose, mouth, ears, clothes, upper left arm, lower left arm, upper right arm, lower right arm, top, bottom, shoes, and the like, and as for the method for such dividing, any algorithm or technique already known in the field of person segmentation may be applied. Then, various effects such as color change, filter application, and background substitution may be applied for each segmented part. For example, a method for naturally changing colors may involve changing the color space into black and white for the region corresponding to the segmentation mask and generating a histogram of the brightness of the converted black and white region, preparing sample colors with various brightness to be changed, generating a histogram of the brightness by also applying on the samples to be changed, and matching the derived histograms using a histogram matching technique, thereby deriving a color to be applied to each black and white region. For example, the histogram matching may be performed so that similar colors are applied to regions having the same brightness. The matched color may be applied to the region corresponding to the segmentation mask.

In an embodiment, the user terminal 200 may be configured to change the clothes of nearby people to emphasize a specific person in the image. Since the most diverse and complex region in the image including a person is the clothing region, the clothes may be corrected to make the surrounding people less noticeable and more emphasize the specific person. To this end, using the artificial neural network model trained to derive the person region from the person image, the person region in the input image may be segmented for each person and derived. Then, each person may be segmented into various parts. In addition, the person to be emphasized in the image may be selected by the user. For example, one person, or several people may be selected. The clothes of people other than the person to be emphasized in the image may be desaturated or if the clothes have colorful patterns, the pattern may be changed to simpler patterns.

In an embodiment, the user terminal 200 may be configured to replace a face in the image with a virtual face. Through this technique, it may be possible to prevent uncomfortableness or annoyance that may occur in viewing the image for indiscriminate use of the mosaic, and also prevent inconvenience in viewing the image by naturally applying a virtual face to ensure that there is no portrait right issue. To this end, the user terminal 200 may generate a segmentation mask corresponding to the face region from the input image by using the artificial neural network model that is trained to derive a face region from the person image. In addition, a new virtual face may be generated using a generative model such as deep learning GAN or the like. Alternatively, Face landmark technology is used so that a newly generated face may be synthesized onto the existing face region.

In an embodiment, in response to detecting a person committing a certain act in the image such as CCTV or black box, this may be notified or a warning message may be transmitted. To this end, it may be enabled to detect what kind of act is being committed in the input image based on the person's pose, by using the artificial neural network model that is trained to predict a pose from an input image including a person. In an example, the act may include violence, theft, disturbance, and the like, but is not limited thereto. In addition, in response to detecting a specific act, the detected information may be transmitted to a required location to give a notification. In addition, in response to detecting a specific act, a high resolution may be set and the image may be photographed at the high resolution. Then, a warning message may be delivered by using various methods such as sound or image based on the detected information. For example, a warning message in different voices and/or image formats suitable for the situations of the act may be generated and transmitted.

In an embodiment, when there is a fire in the input image, not only the temperature or smoke of the fire in the image, but also various environments in the image may be detected to determine that there is a fire. To this end, the artificial neural network trained to predict a fire from the input image may be used to detect whether there is a region with the fire in the input image. Then, in response to detecting a fire, a warning voice may be generated. For example, information such as the location of the fire, the size of the fire, and so on may be automatically generated by voice. The relevant information about the fire may be transmitted to the desired place and/or equipment.

In an embodiment, human traffic, density, staying location, and the like may be detected from the input image, and the purchase pattern may be analyzed. For example, human traffic, density, staying location, and the like in offline stores may be analyzed. To this end, the artificial neural network model that is trained to derive the person region from the image may be used to generate a segmentation mask corresponding to the person region from the input image, and the human traffic, density of the people, the staying location of the people, and the like may be identified based on the derived person region.

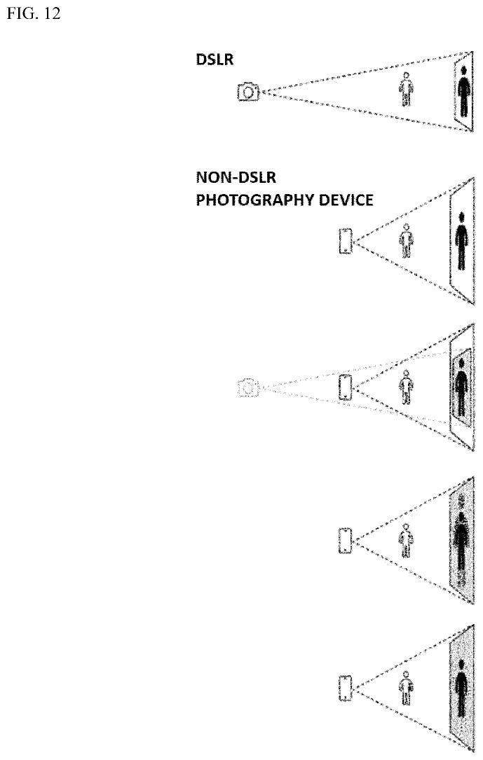

FIG. 12 is an exemplary diagram showing a process of the user terminal 200 of extracting a narrower region from a background in an image and implementing an effect of zooming a telephoto lens as the bokeh blur intensity increases, according to an embodiment. The user terminal 200 may be configured to separate a focusing region and a background region in the image. According to an embodiment, as shown, the separated background region may be extracted to be narrower in the image than the actual region. The extracted background may be enlarged and used as a new background. In response to an input for applying a lens zoom effect, the user terminal 200 may fill in an empty space generated between the focusing region and the background region as the image is enlarged. For example, for a method of filling the empty space, the inpainting algorithm, the reflection padding, or the method of radially resizing and interpolating may be used, but is not limited thereto. For the inpainting algorithm, the deep learning technique may be applied, but is not limited thereto. In addition, when an input for applying a zoom effect is received, the user terminal 200 may apply a super resolution technique to correct for a decrease in the enlarged image quality. For example, for the super resolution technique, a technique already known in the image processing field may be applied. For example, the deep learning technique may be applied, but is not limited thereto. According to an embodiment, when an input for applying a zoom effect is received and the zoom effect is applied on the image, the image quality may be deteriorated, but in this case, the image with the zoom effect applied thereto may be corrected by applying the super resolution technique in real time.

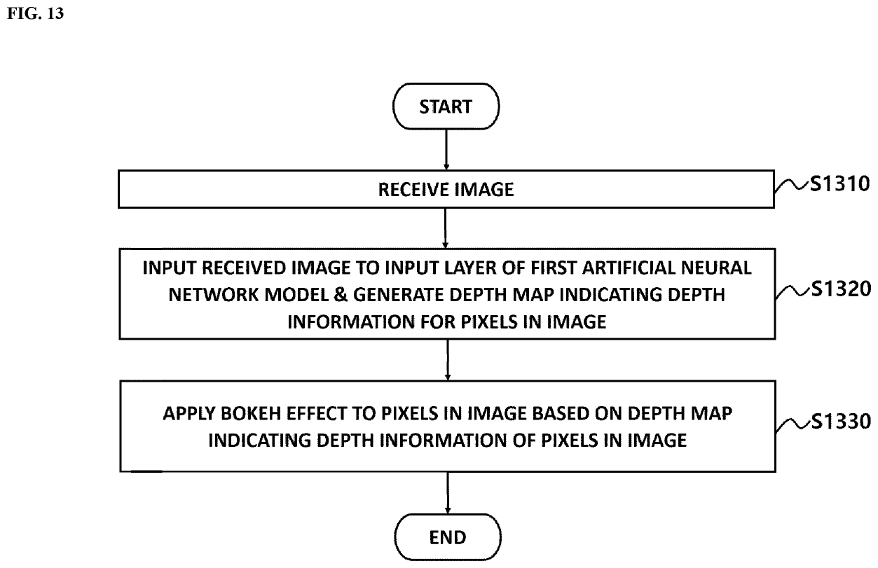

FIG. 13 is a flowchart showing a method of a user terminal according to an embodiment of applying a bokeh effect to an image. The method may be initiated at S1310 of receiving an image from the user terminal. Then, the user terminal may input the received image to the input layer of the first artificial neural network model and generate a depth map indicating depth information for pixels in the image, at S1320. Next, the user terminal may apply the bokeh effect on the pixels in the image based on the depth map indicating depth information of the pixels in the image, at S1330. In an example, the first artificial neural network model may be generated by receiving a plurality of reference images to the input layer and performing machine learning to infer the depth information included in the plurality of reference images. For example, the artificial neural network model may be trained by the machine learning module 250.

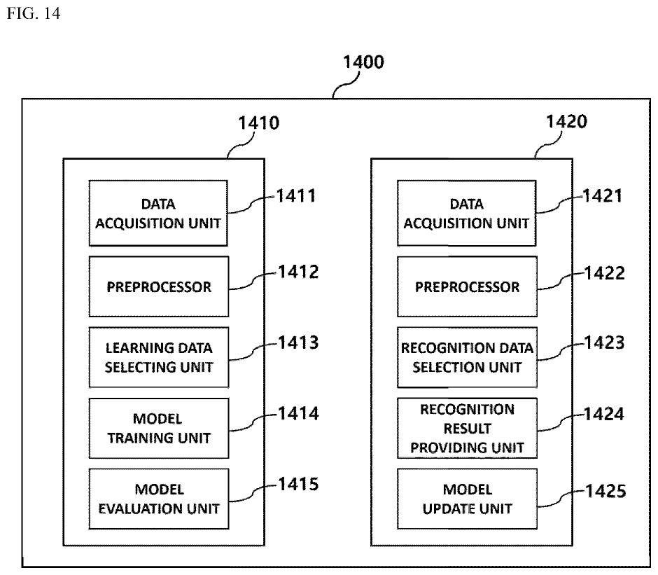

FIG. 14 is a block diagram of a bokeh effect application system 1400 according to an embodiment.

Referring to FIG. 14, the bokeh effect application system 1400 according to an embodiment may include a data learning unit 1410 and a data recognition unit 1420. The data learning unit 1410 of the bokeh effect application system 1400 of FIG. 14 may correspond to the machine learning module of the bokeh effect application system 205 of FIG. 2, and the data recognition unit 1420 of the bokeh effect application system 1400 of FIG. 14 may correspond to the depth map generation module 210, the bokeh effect application module 220, the segmentation mask generation module 230, and/or the detection region generation module 240 of the user terminal 200 of FIG. 2.

The data learning unit 1410 may acquire a machine learning model by inputting data. Also, the data recognition unit 1420 may generate a depth map/information and a segmentation mask by applying the data to the machine learning model. The bokeh effect application system 1400 as described above may include a processor and a memory.

The data learning unit 1410 may be a synthesis of image processing or effects of an image or the like. The data learning unit 1410 may learn a criterion regarding which image processing or effect is to be output according to the image. In addition, the data learning unit 1410 may use the feature of the image to learn a criterion for generating a depth map/information corresponding to at least a certain region of the image or for determining which region in the image the segmentation mask is to be generated. The data learning unit 1410 may perform learning about the image processing or the effect according to the image by acquiring data to be used for learning, and applying the acquired data to a data learning model to be described below.

The data recognition unit 1420 may generate a depth map/information for at least a certain region of the image or generate a segmentation mask based on the image. The depth map/information and/or the segmentation mask for the image may be generated and output. The data recognition unit 1420 may output the depth map/information and/or the segmentation mask from a certain image by using a trained data learning model. The data recognition unit 1420 may acquire a certain image (data) according to a reference preset by learning. In addition, the data recognition unit 1420 may generate the depth map/information and/or the segmentation mask based on certain data by using the data learning model with the acquired data as an input value. In addition, a result value output by the data learning model using the acquired data as an input value may be used to update the data learning model.

At least one of the data learning unit 1410 or the data recognition unit 1420 may be manufactured in the form of at least one hardware chip and mounted on an electronic device. For example, at least one of the data learning unit 1410 and the data recognition unit 1420 may be manufactured in the form of a dedicated hardware chip for artificial intelligence, or may be manufactured as a part of the related general-purpose processor (e.g., CPU or application processor) or graphics dedicated processor (e.g., GPU) and mounted on various electronic devices previously described.

In addition, the data learning unit 1410 and the data recognition unit 1420 may also be mounted on separate electronic devices, respectively. For example, one of the data learning unit 1410 and the data recognition unit 1420 may be included in the electronic device, and the other may be included in the server. In addition, the data learning unit 1410 and the data recognition unit 1420 may provide the model information constructed by the data learning unit 1410 to the data recognition unit 1420 through wired or wireless communication, or the data input to the data recognition unit 1420 may be provided to the data learning unit 1410 as additional training data.

Meanwhile, at least one of the data learning unit 1410 and the data recognition unit 1420 may be implemented as a software module. When at least one of the data learning unit 1410 and the data recognition unit 1420 is implemented as a software module (or a program module including instructions), the software module may be stored in a non-transitory computer readable media that can be read by a memory or a computer. In addition, in this case, at least one software module may be provided by an operating system (OS) or by a certain application. Alternatively, a part of at least one software module may be provided by the operating system (OS), and the remaining part may be provided by a certain application.

The data learning unit 1410 according to an embodiment may include a data acquisition unit 1411, a preprocessor 1412, a training data selection unit 1413, a model training unit 1414, and a model evaluation unit 1415.

The data acquisition unit 1411 may acquire the data necessary for machine learning. Since a large volume of data is required for the learning, the data acquisition unit 1411 may receive a plurality of reference images, depth map/information corresponding thereto, and segmentation masks.

The preprocessor 1412 may preprocess the acquired data so that the acquired data may be used for machine learning through an artificial neural network model. The preprocessor 1412 may process the acquired data into a preset format so as to be used by the model training unit 1414 to be described below. For example, the preprocessor 1412 may analyze and acquire image characteristics for each pixel or pixel group in the image.

The training data selection unit 1413 may select the data necessary for the training from the preprocessed data. The selected data may be provided to the model training unit 1414. The training data selection unit 1413 may select the data necessary for the training from the preprocessed data according to a preset criterion. In addition, the training data selection unit 1413 may also select the data according to a criterion preset by the training by the model training unit 1414 to be described below.

The model training unit 1414 may learn, based on the training data, a criterion regarding which depth map/information and segmentation mask are to be output according to the image. In addition, the model training unit 1414 may train a learning model that outputs the depth map/information and the segmentation mask according to the image as the training data. In this case, the data learning model may include a model constructed in advance. For example, the data learning model may include a model constructed in advance by receiving basic training data (e.g., sample images or the like.).

The data learning model may be constructed in consideration of the application field of the learning model, the purpose of learning, the computer performance of the device or the like. The data learning model may include a neural network-based model, for example. For example, models such as deep neural network (DNN), recurrent neural network (RNN), long short-term memory models (LSTM), bidirectional recurrent deep neural network (BRDNN), convolutional neural networks (CNN), and the like may be used as the data learning models, but is not limited thereto.

According to various embodiments, when there are a plurality of data learning models constructed in advance, the model training unit 1414 may determine a data learning model having a large correlation between the input training data and the basic training data as the data learning model to be trained. In this case, the basic training data may be classified in advance for each data type, and the data learning model may be constructed in advance for each data type. For example, the basic training data may be classified in advance according to various criteria such as the region where the training data was generated, the time when the training data was generated, the size of the training data, the genre of the training data, the generator of the training data, the type of objects in the training data, and the like.

In addition, the model training unit 1414 may train the data learning model using a learning algorithm including error back-propagation or gradient descent, for example.

In addition, the model training unit 1414 may train the data learning model through supervised learning using the training data as an input value, for example. In addition, the model training unit 1414 may train the data learning model through unsupervised learning to discover the criteria for situation determination by self-learning the types of data necessary for situation determination without any supervision, for example. In addition, the model training unit 1414 may train the data learning model through reinforcement learning using feedback on whether a result of situation determination according to learning is correct, for example.

In addition, when the data learning model is trained, the model training unit 1414 may store the trained data learning model. In this case, the model training unit 1414 may store the trained data learning model in a memory of the electronic device that includes the data recognition unit 1420. Alternatively, the model training unit 1414 may store the trained data learning model in a memory of a server connected to the electronic device through a wired or wireless network.

In this case, the memory that stores the trained data learning model may also store commands or data related to at least one other component of the electronic device, for example. In addition, the memory may store software and/or programs. The program may include a kernel, middleware, an application programming interface (API), an application program (or ‘application’) and/or the like, for example.

The model evaluation unit 1415 may input evaluation data to the data learning model, and cause the model training unit 1414 to learn again when a result output from the evaluation data does not satisfy a predetermined criterion. In this case, the evaluation data may include preset data for evaluating the data learning model.

For example, the model evaluation unit 1415 may evaluate that a predetermined criterion is not satisfied, when the number of evaluation data with inaccurate recognition results or ratio of the same in the results of the trained data learning model for the evaluation data exceeds a preset threshold. For example, when a predetermined criterion is defined to be a ratio of 2%, the model evaluation unit 1415 may evaluate that the trained data learning model is not suitable, when the trained data learning model outputs incorrect recognition results for more than 20 evaluation data out of a total of 1000 evaluation data.

Meanwhile, when there are a plurality of trained data learning models, the model evaluation unit 1415 may evaluate whether or not each of the trained image learning models satisfies a certain criterion, and determine a model that satisfies the certain criterion as a final data learning model. In this case, when there are a plurality of models that satisfy a predetermined criterion, the model evaluation unit 1415 may determine the final data learning model with any one or a certain number of models previously set in the order of the highest evaluation scores.

Meanwhile, at least one of the data acquisition unit 1411, the preprocessor 1412, the training data selection unit 1413, the model training unit 1414, or the model evaluation unit 1415 in the data learning unit 1410 may be manufactured in the form of at least one hardware chip and mounted on an electronic device. For example, at least one of the data acquisition unit 1411, the preprocessor 1412, the training data selection unit 1413, the model training unit 1414, or the model evaluation unit 1415 may be manufactured in the form of a dedicated hardware chip for artificial intelligence (AI), or may be manufactured as a part of the related general-purpose processor (e.g., CPU or application processor) or graphics dedicated processor (e.g., GPU) and mounted on various electronic devices described above.

In addition, the data acquisition unit 1411, the preprocessor 1412, the training data selection unit 1413, the model training unit 1414 and the model evaluation unit 1415 may be mounted on one electronic device, or may be mounted on separate electronic devices, respectively. For example, some of the data acquisition unit 1411, the preprocessor 1412, the training data selection unit 1413, the model training unit 1414, and the model evaluation unit 1415 may be included in the electronic device, and the rest may be included in the server.

In addition, at least one of the data acquisition unit 1411, the preprocessor 1412, the training data selection unit 1413, the model training unit 1414, or the model evaluation unit 1415 may be implemented as a software module. When at least one of the data acquisition unit 1411, the preprocessor 1412, the training data selection unit 1413, the model training unit 1414, or the model evaluation unit 1415 is implemented as a software module (or as a program module including instructions), the software module may be stored in a non-transitory computer readable media that can be read by a computer. In addition, in this case, at least one software module may be provided by an operating system (OS) or by a certain application. Alternatively, a part of at least one software module may be provided by the operating system (OS), and the remaining part may be provided by a certain application.

The data recognition unit 1420 according to an embodiment may include a data acquisition unit 1421, a preprocessor 1422, a recognition data selection unit 1423, a recognition result providing unit 1424, and a model update unit 1425.

The data acquisition unit 1421 may acquire the image necessary to output the depth map/information and the segmentation mask. Conversely, the data acquisition unit 1421 may acquire a depth map/information and a segmentation mask necessary to output an image. The preprocessor 1422 may pre-process the acquired data such that the acquired data may be used to output the depth map/information and the segmentation mask. The preprocessor 1422 may process the acquired data into a preset format such that the recognition result providing unit 1424 to be described below may use the acquired data to output the depth map/information and the segmentation mask.

The recognition data selection unit 1423 may select data necessary to output the depth map/information and the segmentation mask from the preprocessed data. The selected data may be provided to the recognition result providing unit 1424. The recognition data selection unit 1423 may select a part or all of the preprocessed data according to a preset criterion to output the depth map/information and the segmentation mask. In addition, the recognition data selection unit 1423 may also select the data according to a criterion preset by the training by the model training unit 1414.

The recognition result providing unit 1424 may apply the selected data to the data learning model and output a depth map/information and a segmentation mask. The recognition result providing unit 1424 may apply the selected data to the data learning model by using the data selected by the recognition data selection unit 1423 as an input value. In addition, the recognition result may be determined by the data learning model.

The model update unit 1425 may update the data learning model based on an evaluation of the recognition result provided by the recognition result providing unit 1424. For example, the model update unit 1425 may cause the model training unit 1414 to update the data learning model by providing the recognition result provided by the recognition result providing unit 1424 to the model training unit 1414.

Meanwhile, at least one of the data acquisition unit 1421, the preprocessor 1422, the recognition data selection unit 1423, the recognition result providing unit 1424, or the model update unit 1425 in the data recognition unit 1420 may be manufactured in the form of at least one hardware chip and mounted on an electronic device. For example, at least one of the data acquisition unit 1421, the preprocessor 1422, the recognition data selection unit 1423, the recognition result providing unit 1424 or the model update unit 1425 may be manufactured in the form of a dedicated hardware chip for artificial intelligence (AI), or may be manufactured as a part of the related general-purpose processor (e.g., CPU or application processor) or graphics dedicated processor (e.g., GPU) and mounted on various electronic devices described above.

In addition, the data acquisition unit 1421, the preprocessor 1422, the recognition data selection unit 1423, the recognition result providing unit 1424 and the model update unit 1425 may be mounted on one electronic device, or may be mounted on separate electronic devices, respectively. For example, some of the data acquisition unit 1421, the preprocessor 1422, the recognition data selection unit 1423, the recognition result providing unit 1424, and the model update unit 1425 may be included in the electronic device, and the rest may be included in the server.

In addition, at least one of the data acquisition unit 1421, the preprocessor 1422, the recognition data selection unit 1423, the recognition result providing unit 1424, or the model update unit 1425 may be implemented as a software module. When at least one of the data acquisition unit 1421, the preprocessor 1422, the recognition data selection unit 1423, the recognition result providing unit 1424, or the model update unit 1425 is implemented as a software module (or as a program module including instructions), the software module may be stored in a non-transitory computer readable media that can be read by a computer. In addition, in this case, at least one software module may be provided by an operating system (OS) or by a certain application. Alternatively, a part of at least one software module may be provided by the operating system (OS), and the remaining part may be provided by a certain application.

In general, the user terminal providing the bokeh effect application system and the service for applying the bokeh effect to the image described herein may refer to various types of devices, such as wireless telephones, cellular telephones, laptop computers, wireless multimedia devices, wireless communication personal computer (PC) cards, PDAs, external modems, internal modems, devices in communication over a wireless channel, and the like. The device may have various names, such as access terminal (AT), access unit, subscriber unit, mobile station, mobile device, mobile unit, mobile phone, mobile, remote station, remote terminal, remote unit, user device, user equipment, handheld device, and the like. Any device described herein may have hardware, software, firmware, or combinations thereof as well as memory for storing instructions and data.

The techniques described herein may be implemented by various means. For example, these techniques may be implemented in hardware, firmware, software, or a combination thereof. Those skilled in the art will further appreciate that the various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design constraints imposed on the particular application and the overall system. Those skilled in the art may implement the described functions in varying ways for each particular application, but such decisions for implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, computer, or a combination thereof.

Accordingly, various example logic blocks, modules, and circuits described in connection with the disclosure herein may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any conventional processor, controller, microcontroller, or state machine. The processor may also be implemented as a combination of computing devices, for example, a DSP and microprocessor, a plurality of microprocessors, one or more microprocessors associated with a DSP core, or any other combination of such configurations.

In the implementation using firmware and/or software, the techniques may be implemented with instructions stored on a computer readable medium, such as random access memory (RAM), read-only memory (ROM), non-volatile random access memory (NVRAM), programmable read-only memory (PROM), erasable programmable read-only memory (EPROM), electrically erasable PROM (EPMROM), flash memory, compact disc (CD), magnetic or optical data storage devices, and the like. The instructions may be executable by one or more processors, and may cause the processor(s) to perform certain aspects of the functions described herein.

When implemented in software, the functions may be stored on a computer readable medium as one or more instructions or codes, or may be transmitted through a computer readable medium. The computer readable medium includes both the computer storage medium and the communication medium including any medium that facilitate the transfer of a computer program from one place to another. The storage media may also be any available media that may be accessed by a computer. By way of non-limiting example, such a computer readable medium may include RAM, ROM, EEPROM, CD-ROM or other optical disk storage, magnetic disk storage or other magnetic storage devices, or any other media that can be used to transfer or store desired program code in the form of instructions or data structures and can be accessed by a computer. Also, any connection is properly referred to as a computer readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer readable media.

The software module may reside in RAM memory, flash memory, ROM memory, EPROM memory, EEPROM memory, registers, hard disk, removable disk, CD-ROM, or any other form of storage medium known. An exemplary storage medium may be coupled to the processor, such that the processor may read information from or write information to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

The above description of the present disclosure is provided to enable those skilled in the art to make or use the present disclosure. Various modifications of the present disclosure will be readily apparent to those skilled in the art, and the general principles defined herein may be applied to various modifications without departing from the spirit or scope of the present disclosure. Accordingly, the present disclosure is not intended to be limited to the examples described herein, but is intended to be given the broadest scope consistent with the principles and novel features disclosed herein.

Although example implementations may refer to utilizing aspects of the presently disclosed subject matter in the context of one or more standalone computer systems, the subject matter is not so limited, and they may be implemented in conjunction with any computing environment, such as a network or distributed computing environment. Furthermore, aspects of the presently disclosed subject matter may be implemented in or across a plurality of processing chips or devices, and storage may be similarly influenced across a plurality of devices. Such devices may include PCs, network servers, and handheld devices.

Although the subject matter has been described in language specific to structural features and/or methodological acts, it will be understood that the subject matter defined in the appended claims is not necessarily limited to the specific features or acts described above. Rather, the specific features and acts described above are described as example forms of implementing the claims.

Although the method mentioned herein has been described through specific embodiments, it is possible to implement it as computer readable code on a computer readable recording medium. The computer readable recording medium includes all kinds of recording devices in which data readable by a computer system is stored. Examples of computer readable recording medium include ROM, RAM, CD-ROM, magnetic tape, floppy disks, and optical data storage devices, and the like. In addition, the computer readable recording medium may be distributed over network coupled computer systems so that the computer readable code is stored and executed in a distributed manner. Further, programmers in the technical field pertinent to the present disclosure will be easily able to envision functional programs, codes and code segments to implement the embodiments.

Although the present disclosure has been described in connection with some embodiments herein, it should be understood that various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method for applying a bokeh effect to an image at a user terminal, comprising:
receiving an image and inputting the received image to an input layer of a first artificial neural network model to generate a depth map indicating depth information of pixels in the image; and
applying the bokeh effect to the pixels in the image based on the depth map indicating the depth information of the pixels in the image,
wherein the first artificial neural network model is generated by receiving a plurality of reference images to the input layer and performing machine learning to infer depth information included in the plurality of reference images.

2. The method according to claim 1, further comprising generating a segmentation mask for an object included in the received image,
wherein the generating the depth map includes correcting the depth map using the generated segmentation mask.

3. The method according to claim 2, wherein the applying the bokeh effect includes:
determining a reference depth corresponding to the segmentation mask;
calculating a difference between the reference depth and a depth of other pixels in a region other than the segmentation mask in the image; and
applying the bokeh effect to the image based on the calculated difference.

4. The method according to claim 2, wherein:
a second artificial neural network model is generated through machine learning, wherein the second artificial neural network model is configured to receive the plurality of reference images to an input layer and infer the segmentation mask in the plurality of reference images; and
the generating the segmentation mask includes inputting the received image to the input layer of the second artificial neural network model to generate a segmentation mask for the object included in the received image.

5. The method according to claim 2, further comprising generating a detection region that detects the object included in the received image,
wherein the generating the segmentation mask includes generating the segmentation mask for the object in the generated detection region.

6. The method according to claim 5, further comprising receiving setting information on the bokeh effect to be applied, wherein:
the received image includes a plurality of objects;
the generating of the detection region includes generating a plurality of detection regions that detect each of the plurality of objects included in the received image;
the generating the segmentation mask includes generating a plurality of segmentation masks for each of the plurality of objects in each of the plurality of detection regions; and
the applying the bokeh effect includes, when the setting information indicates a selection for at least one segmentation mask among the plurality of segmentation masks, applying out-of-focus to a region other than a region corresponding to the at least one selected segmentation mask in the image.

7. The method according to claim 2, wherein:
a third artificial neural network model is generated through machine learning, wherein the third artificial neural network model is configured to receive a plurality of reference segmentation masks to an input layer and infer depth information of the plurality of reference segmentation masks;
the generating the depth map includes inputting the segmentation mask to the input layer of the third artificial neural network model and determining depth information corresponding to the segmentation mask; and
the applying the bokeh effect includes applying the bokeh effect to the segmentation mask based on the depth information of the segmentation mask.

8. The method according to claim 1, wherein the generating the depth map includes performing pre-processing of the image to generate data required for the input layer of the first artificial neural network model.

9. The method according to claim 1, wherein the generating the depth map includes determining at least one object in the image through the first artificial neural network model, and the applying the bokeh effect includes:
determining a reference depth corresponding to the at least one determined object;
calculating a difference between the reference depth and a depth of the other pixels in the image; and
applying the bokeh effect to the image based on the calculated difference.

10. A non-transitory computer-readable recording medium storing a computer program for executing, on a computer, the method for applying a bokeh effect to an image at a user terminal according to claim 1.

11. The non-transitory computer-readable recording medium of claim 10, wherein the method further comprises generating a segmentation mask for an object included in the received image,
wherein the generating the depth map includes correcting the depth map using the generated segmentation mask.

12. The non-transitory computer-readable recording medium of claim 11, wherein the applying the bokeh effect includes:
determining a reference depth corresponding to the segmentation mask;
calculating a difference between the reference depth and a depth of other pixels in a region other than the segmentation mask in the image; and
applying the bokeh effect to the image based on the calculated difference.

13. The non-transitory computer-readable recording medium of claim 11, wherein:
a second artificial neural network model is generated through machine learning, wherein the second artificial neural network model is configured to receive the plurality of reference images to an input layer and infer the segmentation mask in the plurality of reference images; and
the generating the segmentation mask includes inputting the received image to the input layer of the second artificial neural network model to generate a segmentation mask for the object included in the received image.

14. The non-transitory computer-readable recording medium of claim 11, wherein the method further comprises generating a detection region that detects the object included in the received image, and
wherein the generating the segmentation mask includes generating the segmentation mask for the object in the generated detection region.

15. The non-transitory computer-readable recording medium of claim 14, wherein the method further comprises receiving setting information on the bokeh effect to be applied, and wherein:
the received image includes a plurality of objects;
the generating of the detection region includes generating a plurality of detection regions that detect each of the plurality of objects included in the received image;
the generating the segmentation mask includes generating a plurality of segmentation masks for each of the plurality of objects in each of the plurality of detection regions; and
the applying the bokeh effect includes, when the setting information indicates a selection for at least one segmentation mask among the plurality of segmentation masks, applying out-of-focus to a region other than a region corresponding to the at least one selected segmentation mask in the image.

16. The non-transitory computer-readable recording medium of claim 11, wherein:
a third artificial neural network model is generated through machine learning, wherein the third artificial neural network model is configured to receive a plurality of reference segmentation masks to an input layer and infer depth information of the plurality of reference segmentation masks;
the generating the depth map includes inputting the segmentation mask to the input layer of the third artificial neural network model and determining depth information corresponding to the segmentation mask; and
the applying the bokeh effect includes applying the bokeh effect to the segmentation mask based on the depth information of the segmentation mask.

17. The non-transitory computer-readable recording medium of claim 10, wherein the generating the depth map includes performing pre-processing of the image to generate data required for the input layer of the first artificial neural network model.

18. The non-transitory computer-readable recording medium of claim 10, wherein the generating the depth map includes determining at least one object in the image through the first artificial neural network model, and
the applying the bokeh effect includes:
determining a reference depth corresponding to the at least one determined object;
calculating a difference between the reference depth and a depth of the other pixels in the image; and
applying the bokeh effect to the image based on the calculated difference.
